(19) United States
(12) Patent Application Publication
(10) Pub. No.: US 2006/0020533 A1
(43) Pub. Date: Jan. 26, 2006

(54) Computer-implemented program for budgeting and saving

(76) Inventor: Stephon D. Lee, Lawrenceville, GA (US)

Correspondence Address: GARDNER GROFF, P.C., 2018 POWERS FERRY ROAD, SUITE 800, ATLANTA, GA, 30339, US

(21) Appl. No.: 11/191,314

(22) Filed: Jul. 25, 2005

Related U.S. Application Data
(60) Provisional application No. 60/590,644, filed on Jul. 23, 2004.

(51) Int. Cl. G06Q 40/00

(52) U.S. Cl. 705/35

(57) ABSTRACT

A web-based system for budgeting and saving by a client using a team approach. In an example embodiment, the system is configured for client homebuyers to collaborate with third parties such as financial counselors and real estate agents. The clients select third parties to their teams, and a team connect component enables the team members to exchange messages in real time. Based on their collaborative role, the third parties are assigned a class permission that sets their access to the client's information. A collaboration module permits the client to navigate through the website with the client-selected screens also displayed to the third parties, provided they have the required class permission for the displayed information. The reports are sortable by field and configured so the third parties can select one or more clients from the reports and use the team connect component to communicate with all the selected clients simultaneously.

### CROSS-REFERENCE TO RELATED APPLICATION

This application claims the priority benefit of U.S. Provisional Patent Application Ser. No. 60/590,644 filed Jul. 23, 2004, which is hereby incorporated by reference in its entirety.

### TECHNICAL FIELD

The present invention relates generally to systems for budgeting and saving and, in particular, to an Internet-implemented system using a team-based approach for facilitating budgeting and saving for major purchases such as homes.

### BACKGROUND OF THE INVENTION

Many people have the American dream of owning their own home, but have difficulty budgeting and saving money for such a major purchase. Difficulties in budgeting and saving also keep many people from making other major purchases such as automobiles, from saving for major events such as college, vacation, or retirement, and from building wealth in general. This is particularly the case for low-to-middle income families, who often have relatively little disposable income and financial management training.

It is not uncommon for a high percentage of such persons who contact real estate or mortgage agents seeking a home purchase to be disqualified for financial reasons. In a typical scenario, about five out of ten such people do not initially get qualified by the mortgage company. For many of those initially disqualified people, the dream of home ownership forever remains beyond their reach. Many of these people have the will to make their dream come true, but they lack the financial management knowledge and experience to formulate a budget and to stick to it, so they never become financially qualified for a home purchase.

For some other people who do not initially get qualified, they will need to budget and save for a while to be ready to purchase a home. But the real estate agents and mortgage representatives who worked with the person up until their mortgage application was initially denied do not usually stay in regular touch with these people. Instead, they normally just ask these potential clients to repair their finances and then get back in touch with them. The real estate agents and mortgage representatives leave it to chance that these potential clients will return and do business with them once their financial position has improved. Neither the real estate agents nor the mortgage representatives have the time or means to regularly work with these potential clients on an individual basis in the hope that some of them will become qualified and turn into a sale. Some of those people that do in fact improve their financial position will then use other real estate agents and mortgage representatives when making their home purchase, resulting in lost sales to the agents and representative who initially worked with the person.

Accordingly, it can be seen that a need exists for a convenient and easy-to-use system that provides education and assistance in budgeting and saving for major purchases and events such as homes, and that also uses a team-based approach allowing the continued involvement of real estate agents, mortgage representatives, financial/housing counselors, and others. The need exists for the system to be designed so that is user-friendly, interactive, and provides efficiency and value-added benefits to each participating team member. The need exist to provide functionality that allows client-users the ability to collaborate and share data, at the clients' and team members' convenience. The need exists to enhance the client's probability of financial success by providing an efficient and effective means for working together with its team members from remote locations. It is to the provision of such a budgeting and saving system that the present invention is primarily directed.

### SUMMARY OF THE INVENTION

Generally described, the present invention provides a computer network-implemented system for budgeting and saving. The invention is preferably embodied in a website provided by a computer-readable storage medium that is programmed with computer-executable instructions and data and loaded onto one or more server computers that are connected to a computer network such as the Internet. Users of the system include clients who are looking to budget and save toward their goal and their third-party users who collaborate with the clients to help them achieve their goals.

In a first example embodiment of the present invention, the system includes a database storing financial information such as budget information, actual information, and budgeting results for each of the clients; a budgeting component for calculating the budgeting results based on the budget and actual information; a report generator for generating reports based on the financial information; a team building component for the clients to select third parties as team members who are permitted remote access to the client's reports; and a team connect component for the team members to share data and exchange messages amongst themselves in real time. By using the system, the clients and the client-selected third party team members can collaborate from remote locations to facilitate improved budgeting and saving by the client.

In one aspect of the invention, the third parties are assigned class one permissions or class two permissions, and based on their permissions class they are permitted different levels of access to the client's information store on the server. For example, in the situation where the client is a prospective homebuyer, the client might select a team of a financial counselor with class one permissions, and a real estate agent and a mortgage representative with class two permissions. The financial counselor (class one) is permitted a higher lever of access and can view the client confidential financial reports (e.g., a budget analysis report), but the real estate agent and a mortgage representative (class two permissions) cannot. On the other hand, the system is set up so that for other reports, such as a client progress report, access is permitted to both class one and class two team members. In this way, the team members are permitted access to the information that they need in order to help in the collaborative process, and the client retains control over its confidential information.

In another aspect of the invention, the team connect component includes a collaboration module for use by the team members. The client and the third party teams online at the time can view the same information, and as the client navigates through the website the screens that the client selects for viewing are also displayed to the third party team members. The third party team members are in a “view only” mode, and the client controls and drives the process. In addition, the class permissions apply such that the class two team members (e.g., real estate agents and mortgage representatives) do not have access to web pages selected by the client if the webpage has confidential financial information and is assigned a corresponding permissions requirement.

In another aspect of the invention, the reports generated by the system include third party reports with client-specific information for the included clients. The client-specific information is arranged in fields and sortable by the fields. A third party team member can sort by the fields to identify budgeting status of the included clients, then select one or multiple clients from the client progress report and send a message to all of the selected clients simultaneously. Preferably, the system is configured so that the team connect component can be used for the real time messaging.

In a second example embodiment of the invention, the system includes three modules for budgeting for (1) home ownership; (2) higher education and life skills; and (3) sound financial management and good stewardship. Accordingly, the target groups for using the system include, for example, prospective homebuyers, high school and college students, and church members, who all use the same web site. And the system is adapted for use by these persons. For example, for the second module for high school and college students, a person can be selected as a class-one third-party team member. And for the third module for churches, a church volunteer can be selected as a class-one third-party team member. Other modifications will be understood by a person of ordinary skill in the art.

The specific techniques and structures employed by the invention to improve over the drawbacks of the prior systems and accomplish the advantages described herein will become apparent from the following detailed description of example embodiments of the invention and the appended drawings and claims.

### BRIEF DESCRIPTION OF THE DRAWING FIGURES

FIG. 1 is a functional block diagram illustrating a budgeting and saving system according to a first example embodiment of the present invention.

FIG. 2 is a logic flow diagram showing a method of budgeting and saving using the system of FIG. 1.

FIG. 3 is an exemplary “welcome” screen for display on a client user's interface device.

FIG. 4 is an exemplary “build your team” client display screen.

FIG. 5 is an exemplary “goal-setting” client display screen.

FIG. 6 is an exemplary “budget” client display screen.

FIG. 7 is an exemplary “budget-liabilities” client display screen.

FIG. 8A is a portion of an exemplary “post actuals” client display screen.

FIG. 8B is a continued portion of the exemplary “post actuals” client display screen of FIG. 8A.

FIG. 8C is a continued portion of the exemplary “post actuals” client display screen of FIG. 8B.

FIG. 9A is a portion of an exemplary “budget analysis” client display screen.

FIG. 9B is a continued portion of the exemplary “budget analysis” client display screen of FIG. 9A.

FIG. 10 is an exemplary “reporting” client display screen.

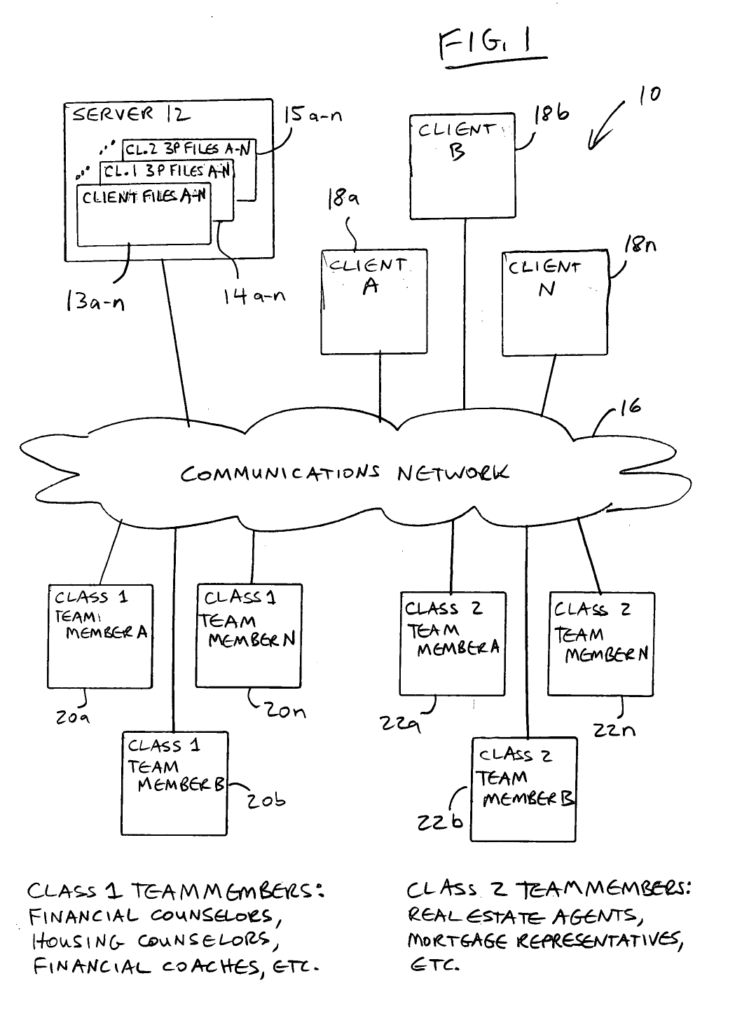

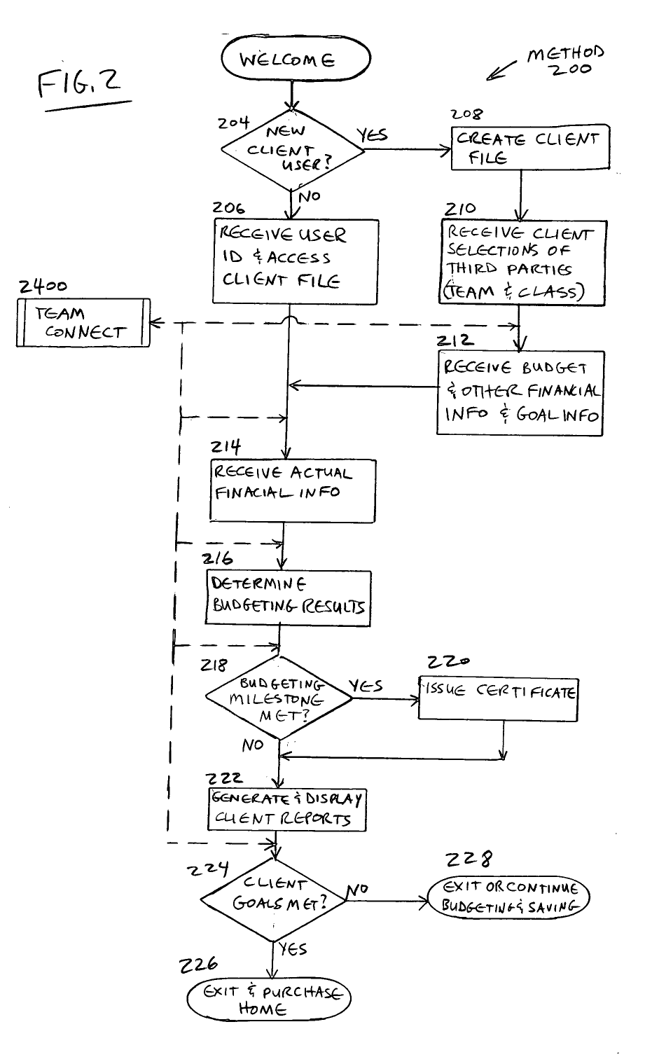

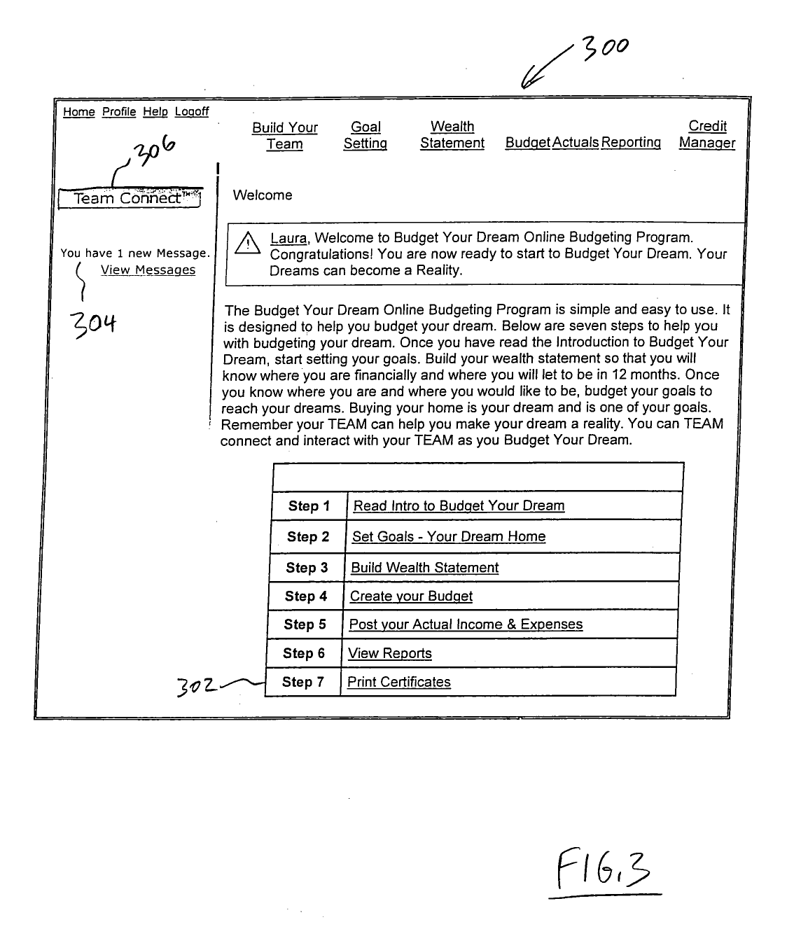

FIG. 1A is a portion of an exemplary “budget analysis report” client display screen.

FIG. 11B is a continued portion of the exemplary “budget analysis report” client display screen of FIG. 111A.

FIG. 12 is a logic flow diagram showing a method for third parties to use the system of FIG. 1 to collaborate with clients in their budgeting and saving.

FIG. 13 is an exemplary “my clients” screen for display on a financial counselor third party user's interface device.

FIG. 14 is an exemplary “my clients” financial counselor display screen that has been sorted by field.

FIG. 15 is an exemplary “reporting” financial counselor display screen.

FIG. 16A is a portion of an exemplary “budget analysis report” financial counselor display screen.

FIG. 16B is a continued portion of the exemplary “budget analysis report” financial counselor display screen of FIG. 16A.

FIG. 17 is an exemplary “client progress report” financial counselor display screen.

FIG. 18 is an exemplary “client progress report” financial counselor display screen that has been sorted by field.

FIG. 19 is an exemplary display screen showing the financial counselor using the team connect to send a group message to two selected clients.

FIG. 20 is an exemplary “my clients” screen for display on a real estate agent third party user's interface device.

FIG. 21 is an exemplary “reporting” real estate agent display screen.

FIG. 22 is an exemplary “client progress report” real estate agent display screen.

FIG. 23 is an exemplary “client progress report” real estate agent display screen that has been sorted by field.

FIG. 24 is a logic flow diagram showing the process flow for the team connect component.

FIG. 25 is a logic flow diagram showing the process flow for the silent post-back process of the team connect component.

FIG. 26 is an exemplary display screen showing the team connect component in use for exchanging messages.

FIG. 27 is a functional block diagram illustrating a budgeting and saving system according to a second example embodiment of the present invention.

### DETAILED DESCRIPTION OF EXAMPLE EMBODIMENTS

The present invention provides a system with unique features for educating and assisting client users in budgeting and saving for major expenses. In preferred embodiments, the system is embodied in a website accessible via a global computer network such as the Internet. Accordingly, the computer program for the website is stored and maintained on one or more server computers connected to the Internet and configured for remote accessing by the general public by wired or wireless Internet-connected user devices such as personal computers, laptops, personal digital assistants (PDA's), cell phones, etc. In alternative embodiments, the program may be implemented on other computer networks (WAN's, LAN's, etc.) configured for accessing by the intended users.

The system is configured for budgeting for various goals, or can be readily adapted for those uses. In exemplary embodiments, the program includes three modules for budgeting for (1) home ownership; (2) higher education; and/or (3) good stewardship. Accordingly, target groups for using the system may include prospective homebuyers, high school seniors and college students, and/or church members. All three of these modules can be combined into a single computer program, some but not all can be combined into a single program, or they can each stand alone as separate programs targeted to their specific user groups. It will be understood that other similarly configured modules can be integrated into the computer program to provide for budgeting and saving for other major expenses such as automobiles, vacations, retirement, etc.

The following terminology us used throughout the specification and claims. A “user” is anyone using the system. A “client” is a user who is using the system for budgeting and saving. A “third party” is a user who is using the system to collaboratively support and assist the client. A “team” is a collaborative group of users including at least one client team member and at least one client-selected third-party team member.

Generally described, in a preferred embodiment the system is configured to provide an online budgeting service designed to produce budgeting success for client users pursuing their dream of home ownership. The service is a simple, effective, and efficient way to help persons budget their dreams online using a value-added collaborative approach. The program preferably includes modules for goal setting, prioritizing goals, building wealth statements, creating budgets, posting actual income and expenses, analyzing budgets, and/or generating reports such as debt worksheets, monthly budgets, personal financial statements, housing affordability calculations, expense statements, and/or summary reports. The website is very user-friendly and includes a help module for providing responses to guide the clients when preparing budgets.

In addition, the system uses a team-based approach that provides the client users with the opportunity for collaboration with third party users. For example, a client seeking to purchase a home can build its team with a financial counselor, a real estate agent, and a mortgage representative. Or a parent with a child in high school or college might include on its team the parent, a teacher, and a financial counselor. The financial counselors can be anyone selected by the client who is enrolled in the service, such as accountants, investment advisors, financial planners, or other financial advisors, friends or family members, or other persons of choice. The real estate agents and mortgage representatives will also have to be enrolled in the service in order to be selected by the client as a team member. The team members can be of great value by counseling the client to help learn how to budget and build wealth. The client has the discretion to select its desired third party team members and grant them access to the client's files in the database on the server computer. Access is granted based on the third party member's permission class. In addition, the system allows the clients to work independently if they'd rather not take advantage of the collaborative opportunity.

Preferably, the system automatically generates predetermined reports once a client reaches certain milestones in preparing monthly budgets, and generates an award certificate of other indication of budgeting success when a client meets the milestones. For example, one of the milestones may be the client meeting its budget for a predefined number of months (e.g., six months). The certificates are recognized by the team member mortgage representatives as a favorable indication of the client's improved financial position. When the client has demonstrated the improved budgeting and saving skills necessary to obtain the certificates, the mortgage representatives know they now have a client that is more likely to be able to stay in good shape financially and regularly pay their mortgage. Therefore, the mortgage companies who have joined the service grant a reward to clients who have earned one or more of the certificates. For example, the reward may be qualifying earlier for financing, a discount at closing (i.e., $50 off for each six-month successful budgeting certificate), a more favorable interest rate, or another reward that is applicable to a home purchase. The mortgage companies are preferably required to accept the certificates in order to participate in the program.

In addition, by taking advantage of features provided by the team-based, collaborative approach, the system is an effective and efficient management tool for the client-selected third-party team-member users (particularly real estate agents and mortgage representatives). The system provides the third party team members with access to the database files for the potential clients on their teams. The clients enter data into the database, and the system is configured to provide the third parties the ability to generate reports that allow them to identify the potential clients that are successfully budgeting and making themselves most ready to purchase a home. In order to generate reports to identify target potential clients from the client database, the system is configured to allow the third parties to select from various criteria. For example, reports can be generated that list clients in the database based on their planned home purchase date, the number of months of successful budgeting, the client's desired home purchase price, and a system-generated calculation of the client's affordable home purchase price. These various reports are accessible to the third parties continuously via web access.

In addition, the client files in the database include profiles with key data on the clients. The original data entered by client when enrolling remains in the database until the client changes the data that initially entered. For those client team members that were initially denied credit and are delaying their home purchase, the third party team members no longer have to worry about lost contact information or other key data on these potential clients. The client information is maintained online and can easily be accessed at any time.

Moreover, the client files are created and updated by the clients themselves as they use the budgeting and saving system, with little to no effort by the third party users. Thus, through the tangible incentive of home ownership, the clients are motivated to use the system, and in so doing they build a database that has value and is accessible by the third party team members. The third party team members can save or download their client team member files for their use, including generating reports based on budgeted and actual financial data entered by the clients.

Furthermore, the system preferably includes a “team connect” feature by which all the team members can interact and communicate in real time. The team members can click a button on the website to enter the team connect function and easily and immediately interact and communicate with other team members currently online and using the system. This function allows the third party team members to easily build client relationships with those clients that are most valuable to them for future sales opportunities. For example, real estate agents can send messages to individual clients or to a group of clients based on any criteria they select such as consecutive months of budgeting success. This feature makes it easy and simple for the third party team members to maintain relationships with client team members who were initially declined financing while they undertake further budgeting and financial repairs. And the system allows those third party team members that desire to be more involved in the client's budgeting process to do so by using the team connect feature to more frequently communicate with and counsel the clients on their team. Accordingly, the team connect feature is especially valuable to real estate agents and mortgage representatives who do not have an organized system to manage the clients who were initially denied credit. As mentioned above, in a typical scenario about five out of ten individuals seeking to purchase a home do not qualify initially. In this scenario, the real estate agent might eventually realize an additional five clients (those initially disqualified who would not be able to purchase a home except by using the system). Thus, using the system results in an increase in home and mortgage sales for the third party real estate agents and mortgage representatives.

For financial and housing counselors, they too stand to benefit from using the system. Clients who have used the system and improved their financial position tend to make better customers. For example, for-profit financial advisors gain clients who might then go on to purchase other financial services such as investment products. And financial or housing counselors with non-profit organizations can expect to gain donations to their organizations (and other worthy organizations) as a result of their work in helping the clients improve their financial position. The financial and housing counselors gain tremendous efficiency by utilizing the system. The system provides the financial and housing counselors the ability to monitor, track and evaluate their clients' progress and financial success with easy access via the computer at anytime and anywhere. The system provides up-to-date information on clients' budgeting success. The system has automated the budgeting calculations and analysis; therefore saving the financial and housing counselors a minimum of 30 minutes per client per month. For example, a financial counselor counseling 200 clients per month can save a minimum of 100 hours of counseling time per month. The financial and housing counselors gain various efficiencies from using the system. Given the ease of viewing client progress summary reports, the financial and housing counselors will be able to quickly identify those clients that are in most need of counseling. With this information, the financial or housing counselor could more efficiently and effectively allocate their time to clients in most need of counseling services. The result of the counselors better allocating their time and energy will be a savings in cost or an increase in donations for the services rendered. The efficiency gained from the system multiplies with the increase in client-users. Generally speaking, when the clients use the system to budget and save for their dreams, not only are they are able to purchase their homes, but they are also able to save for other goals, build wealth, purchase other products and services, and maintain healthy long-term business relationships with those third parties and other companies with whom they conduct business.

Accordingly, the system provides a number of unique and advantageous features, including:
1. web-based budgeting and personal financial management features;
2. an incentive-based approach for prospective homebuyer clients and third party team members;
3. a team approach (collaboration) including third party users to promote sound financial management/budgeting;
4. an incubator for potential sales for third party users;
5. a client relationship management tool for third party users;
6. a tool that automates budget calculations, analysis and determination of clients' financial success utilizing the system's unique test methodology and parameters;
7. a tool that provides 1) clients with interactive feedback (for learning and managing) and 2) third party team members with an indicator of clients' financial success;
8. an easy-to-use and effective tool that provide the ability to monitor, track, and evaluate clients' financial progress;
9. a tool to allow clients to build or delete team members in order to work collaboratively or independently; and
10. a tool that provides a third party organization an increasing efficiency and economy of scales based on the system's unique ability to organize, process, and manage a large database of clients data throughout the clients' budgeting experiences.

With these advantages, the system is an effective and innovative tool for helping people to learn to prioritize, budget, and save. In the process, real estate and/or mortgage agents can track the progress of the clients, and assist them in meeting their budget and savings goals. In the end, the real estate and/or mortgage agents gain additional clients and sales as well.

In a preferred embodiment, to fund the system the clients would pay a nominal fee, for example, about $10 per month, or $25 to register. Because of the benefit to financial counselors, real estate agents, mortgage representatives, and other third party users, they may be required to pay a fee, for example, $25 annually. Other fee structures and funding schemes could alternatively be used. In addition, the system preferably includes an administrative feature that permits users, at the click of a button, to transfer from one service provider of the system to another. Thus, with the system licensed to various third party organizations who enroll clients, those clients can later transfer their membership to another service provider and all of their data will be transferred without having to reenter it.

Turning now to the drawing figures, in which like reference characters indicate like elements throughout the several figures, FIG. 1 is a functional block diagram illustrating the system architecture of a budgeting and saving system 10 according to a first example embodiment of the present invention. The system 10 is configured for budgeting and saving primarily for home purchases for use by prospective homebuyer client users. The system 10 includes a computer server 12 with a processor and a computer-readable storage medium such as one or more hard drives, CD-ROM discs or other media for an optic drive, and/or magnetic tapes, discs, or other media for such a drive. The storage medium stores the main website program and a database with files 13a-n, 14a-n, and 15a-n for the client users and third party users. The client files 13a-n include profile, team, and financial information for the client users, and the third party user files 14a-n and 15a-n include profile and team information for the third party users.

The system 10 is preferably implemented as a website accessible via a global computer network. Accordingly, the server 12 has an on-line interface configured to communicate with numerous remote user devices via a communications network 16 such as the Internet, a wireless network, or another computer network. Alternatively, the server can be connected to a computer network such as an intranet or a LAN for use by users who are local to the server, such as on a college or corporate campus. The user devices include client user devices 18a-n, class-one team-member user devices 20a-n, and class-two team-member user devices 22a-n. These user devices may include desktop computers, laptop computers, hand-held computers, PDA's, web-enabled phones, or other communication devices connected to the network. It will be understood that other system architectures can be employed to provide the functionality described herein.

The users of the system 10 include clients and interested third parties. In this embodiment, the clients are the prospective homebuyers, and the clients build a collaborative support team by selecting team members from the enrolled third parties. When the third parties enroll they indicate their collaborative role and, based on that role, they are assigned a permissions class. The permissions classes relate to the level of access the third party team members get to the client team members' financial information. For example, class one team members may include financial counselors, housing counselors, and/or financial coaches, who are granted full access to all of the clients' confidential financial information. Financial counselors include professional financial advisors and planners, whether with a governmental, non-profit, or for-profit organization. Housing Counselor include professional housing counselors. Financial coaches include relatives, friends, teachers, church volunteers, etc. Class two team members may include real estate agents and/or mortgage representatives, who are granted a restricted level of access to only the information of relevance to them. Real estate agents include licensed real estate agent and brokers. And mortgage representatives include licensed mortgage brokers and professional loan officers or originators employed by a mortgage broker or lender. It will be understood that an individual may participate on a team in multiple capacities. For example, a bank employee could enroll as a financial coach and as a loan originator, and be selected by the client as a team member to collaborate in both roles.

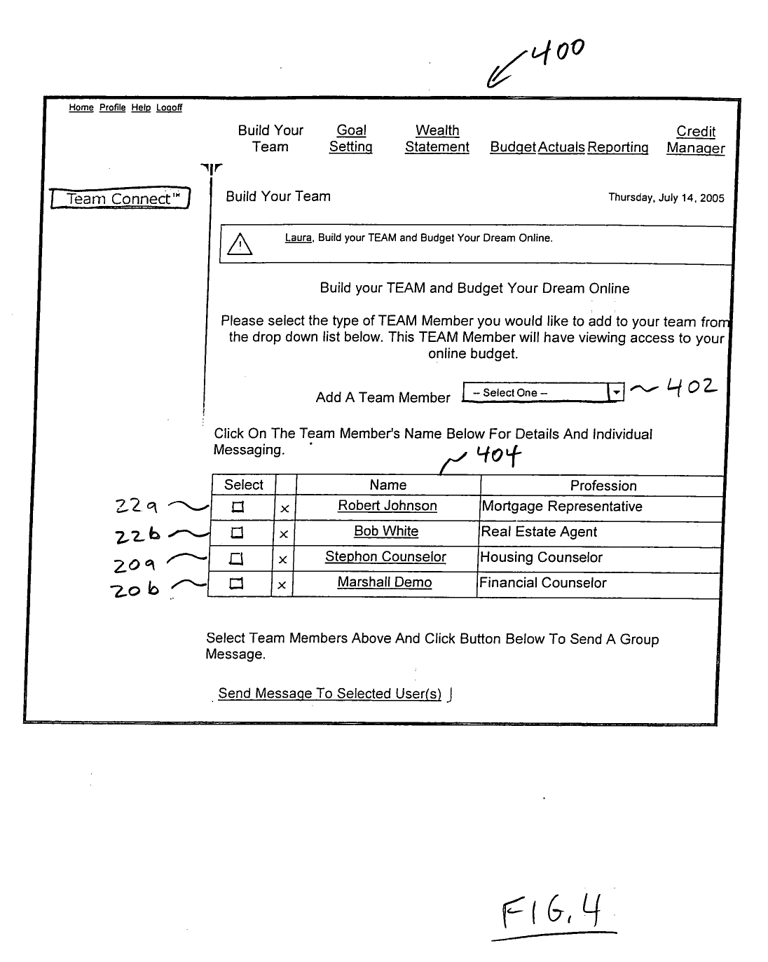

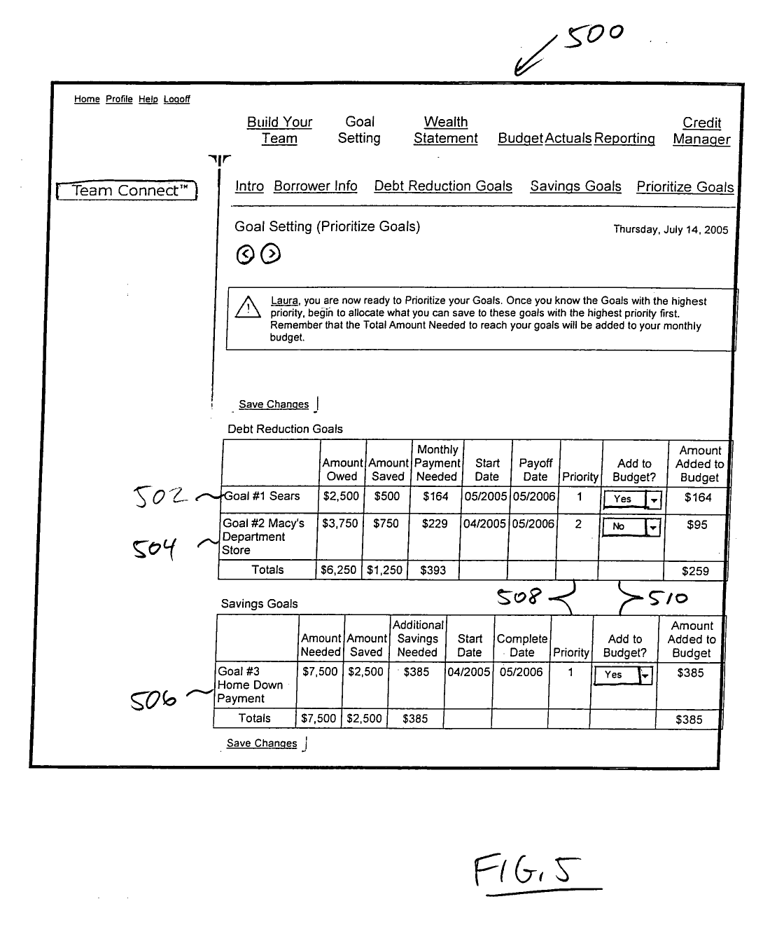

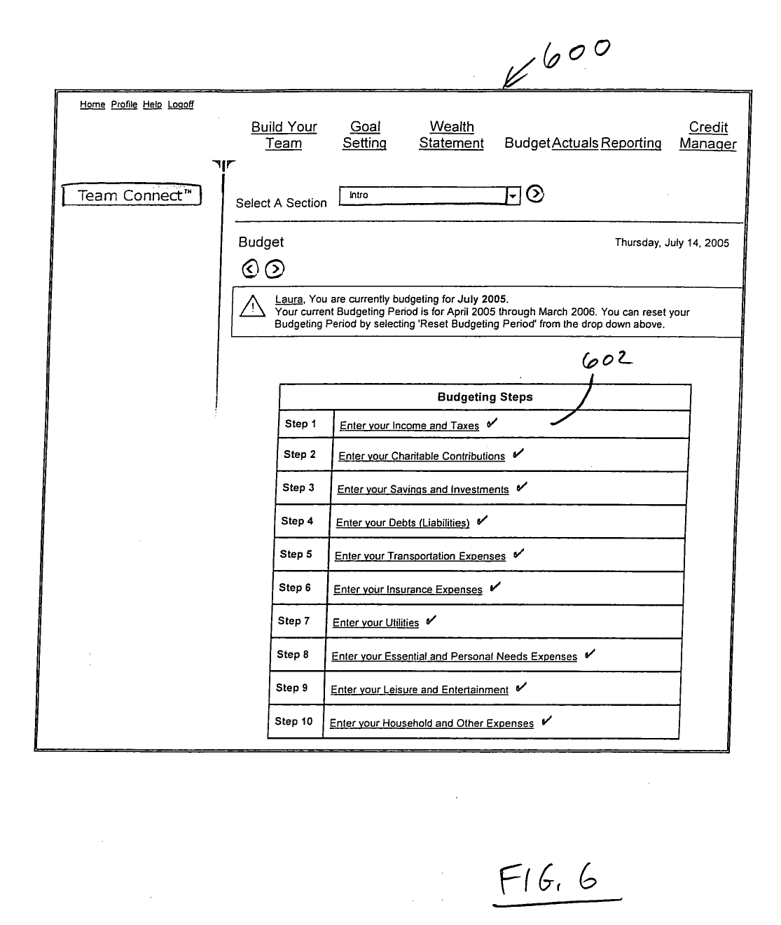

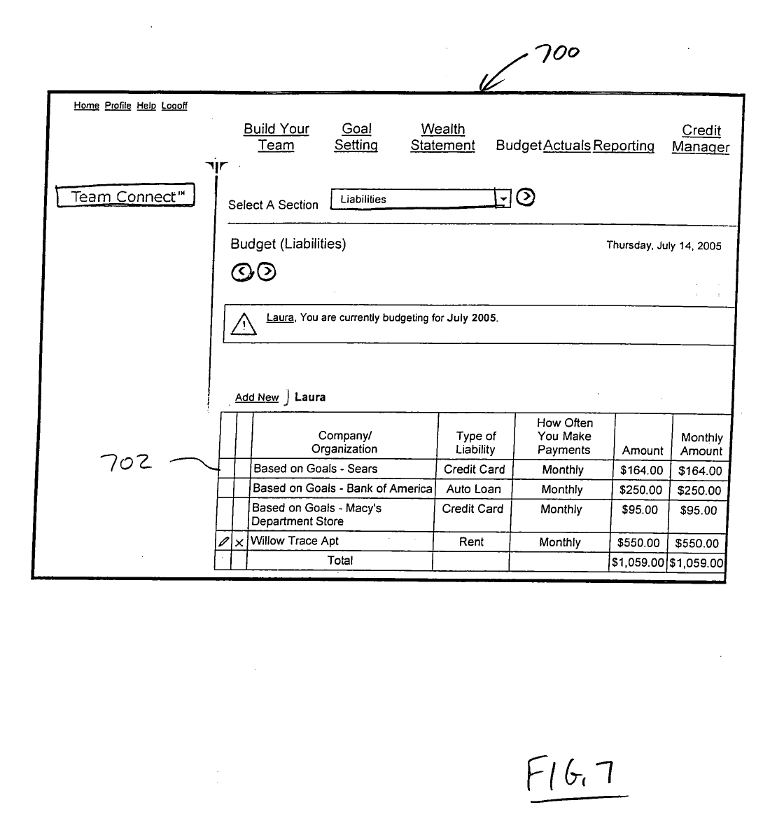

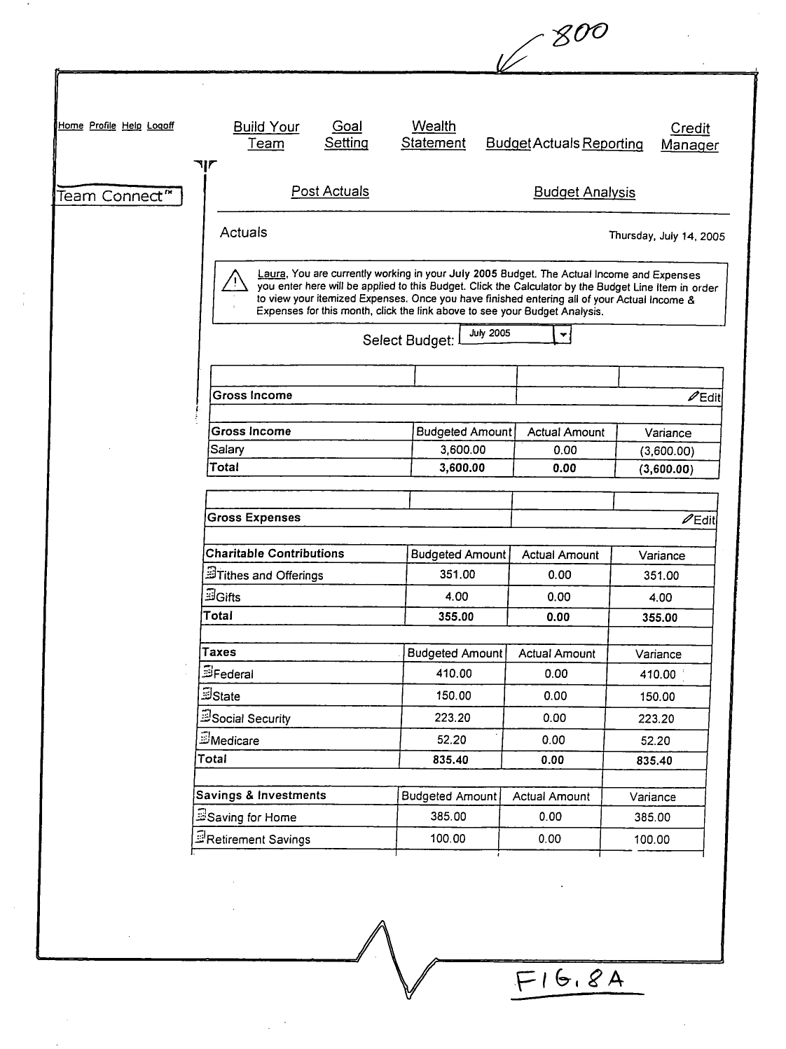

FIG. 2 is a logic flow diagram showing a method 200 of using the system 10 of FIG. 1 for clients. Thus, the method 200 can be implemented as an application service provided by a computer server connected to a communications network such as the Internet. The server is programmed to carry out the functionality of the method 200, which programming can be performed by a computer programmer of ordinary skill in the art. In addition, FIGS. 3-11B depict a series of exemplary screen shots correlated to the steps of the method 200. It will be understood that the screen shots in the drawing figures are representative of the invention, and not limiting. That is, the invention can be implemented by a website or other computer program with additional and/or different screen shots, and/or with screen shots including different graphics, text, and data fields.

The method 200 includes at 202 the server sending a homepage screen to the user for display on its on-line user interface device. At 204 the process flow splits depending on whether the user is a new user or not.

If the user is an existing user, it can click a “login” button displayed on the homepage for entering at 206 one or more user identifiers such as a user name and password, an email address, etc. The server then accesses the user's file by finding the file on the storage medium that is correlated to the user's identifier. A plurality of user files are stored on the storage medium, with each file preferably dedicated to one the users.

If the user has not used the service before, it can click an “enroll” button displayed on the homepage and indicate the user type to begin the enrollment process. In this case, the user is a client, so the user selects the client type from a drop-down menu. Then at 208 a new client enrollment screen is displayed for the client to enter certain required information that is saved as a new client file in the database. Here the client user is provided with fields for entering information such as its name, contact information (mailing address, phone number, fax number, email address, etc.), user name and password, security information such as a user identifier (e.g., its password), billing information, and so forth.

After the client is enrolled, and whenever it accesses the website and enters its login information in the future, a customized “welcome” screen is displayed to the client. An exemplary welcome screen 300 is shown in FIG. 3. From here or any other page on the website the client can navigate through the website pages to update its profile information, to access the help feature, to use the various budgeting-related features, or to use the team connect component. The various budgeting-related features will be described next, and the team connect component will be described in due course.

To proceed with the various budgeting-related features, at 210 the client first uses a team-building component to assemble its collaborative team of third party users. The team-building component includes a “build your team” screen that is sent to the user's interface device for display. The client uses the build your team screen to enter its team selections of third party users, and this team information is saved to the clients file.

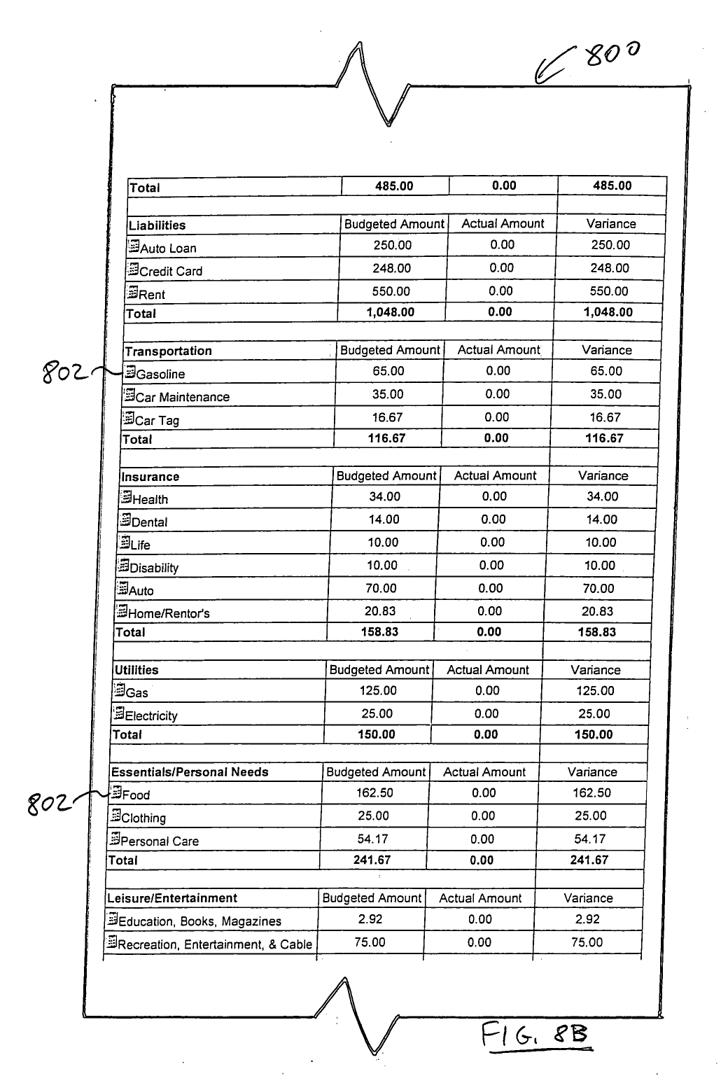

An exemplary build your team screen 400 is shown in FIG. 4, and can be accessed by clicking the build your team button. This screen preferably includes a drop-down menu 402 for entering selections of third party users enrolled in the program. In addition, this screen preferably includes fields 404 displaying the third party users that the client has previously selected as team members on its team. In this case, the client has selected for its team a mortgage representative 22a, a real estate agent 22b, a housing counselor 20a, and a financial counselor 20b. As mentioned above, these selected team members will have two different levels of access to the client's information. For example, the housing counselor 20a and the financial counselor are class-one third-party team members and as such will have a higher level of access. And the mortgage representative 22a and the real estate agent 22b are class-two third-party team members and as such will have a lower level of access. If desired, the system can be designed with three or more classes of permissions, or with only one.

At this point, the client has built its team. So the client can use the team connect component to collaborate with its team members at any point in the process, as will be described elsewhere. The client can add or delete team members as the need may arise.

Next, at 212 the client proceeds to initialize its goals and financial data in its file. The client uses a goal-setting component to enter its goals. Typically, the client's goal is to save a down payment amount for a home purchase. Also, the client might have as its goal to reduce its credit card debt, to save for another major expense such as college or retirement, or to reduce other debt such as college loans. The goal-setting component includes one or a series of goal-setting screens for the client to enter and prioritize its goals, and all of this goal information is saved to the client's file.

An exemplary prioritize goal-setting screen 500 is shown in FIG. 5. This screen can be accessed after the client has entered certain joint-client and home purchase information (e.g., planned purchase date, desired purchase price, planned down payment amount, desired interest rate) and its goals (debt reduction and/or savings), and is ready to prioritize them. In this case, the client has entered for its goals reducing debt on two credit cards at 502 and 504 and saving a down payment for a home purchase at 506. In addition, the goal-setting screen 500 has fields at 508 for prioritizing the goals, and the client has entered priorities for these goals, with one of the credit cards 502 having a higher priority than the other card 504. Having established the priority of the goals, the client can now work on the higher priorities first, which helps teach financial management skills. To assist in this purpose, the screen 500 has fields at 510 for selecting the goal amounts to be imported into to the client's budget. The client can change the amount to be added to the budget by selecting “yes” of “no” from the drop down box field 510 for either a debt-reduction or savings goal. If the client selects “no” at field 510 for a debt-reduction goal, the system will then add the “minimum monthly payment” to the budget. If the client selects “yes”, the system will add the “monthly payment needed” for early payoff to the budget. If the client changes the amount for a savings goal and selects “no”, the system will add zero dollar amounts to the budget. If the client selects “yes” on a savings goal, the system will add the monthly “additional savings needed” for that savings goal to the budget.

In addition, at 212 the client uses a budget component to enter its budget financial information. The budget component displays a “budget” screen that the client uses to systematically create its budget, for example, by entering each budget item, its frequency (e.g., monthly), and the budgeted amount. Then all of this budget information is saved to the client's file. For example, the budget screen preferably displays fields for entering budget financial information including regular and predictable income and expenses such as salary, charitable contributions, insurance, utilities, leisure/entertainment expenses, and the like. In addition, the budget screen preferably displays fields for the debt reduction and saving goal amounts entered in the goal-setting screen 500.

An exemplary budget screen 600 for use as just described is shown in FIG. 6. As shown, the budget screen 600 includes budget categories 602 with links to pages having fields for entering the budget financial information. And FIG. 7 shows a “liabilities” screen 700 including a credit card debt 702 that was added from item 502 of goal-setting screen 500.

It will be understood that the client can use the system to enter its budget financial, its goals, and its team member selections in a different sequence, if desired. But building the team first advantageously permits the client to use the team connect component for collaboration (including information sharing and the client navigating the third party team members through the webpages, as described below) with its team members when undertaking the goal-setting and budgeting. And entering the goals before creating the budget advantageously permits the client to import a debt reduction or savings goal to its budget by selecting the field 510 on screen 500, as described above.

In addition, the website preferably includes a wealth statement component, a checking account component, a debt scheduling component, and a credit manager component. Using the wealth statement component, the client can create a wealth statement showing, for example, current value, desired value in 12 months, amount of change, and percent change for the client's assets and liabilities. The assets can include checking account, savings account, mutual funds, personal residence, furniture and equipment, jewelry and coin collections, automobile, and business interests, and the liabilities can include mortgage, rent, auto loan, credit card, and school loan. And the credit manager component can be used to track information on any collection agency actions, past due credit accounts, etc., and it includes links to the major credit reporting agencies.

At this point, whether a new or existing user, the client is set up and initialized in the system. With its budget and team in place, the client now proceeds to use these to work towards achieving its goals. The client can logon to the website remotely from anywhere there is Internet access to update its information and/orto use the team connect component to collaborate with its third party team members, as described below.

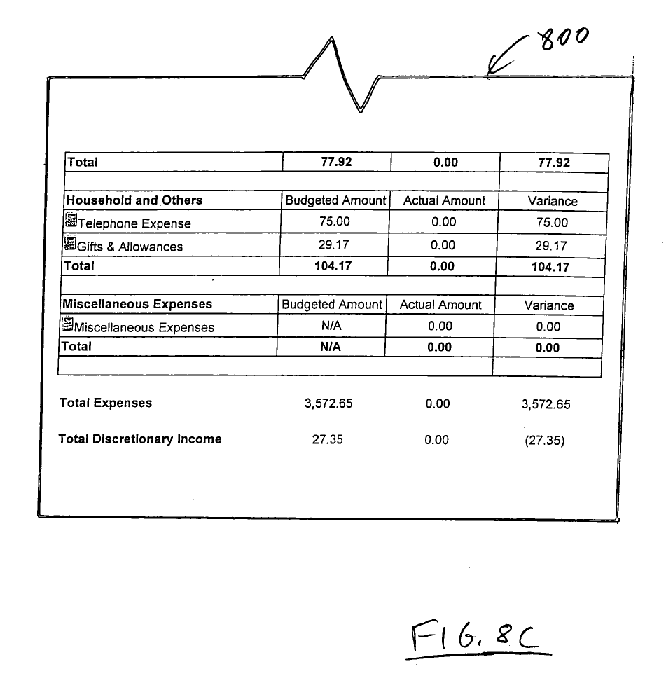

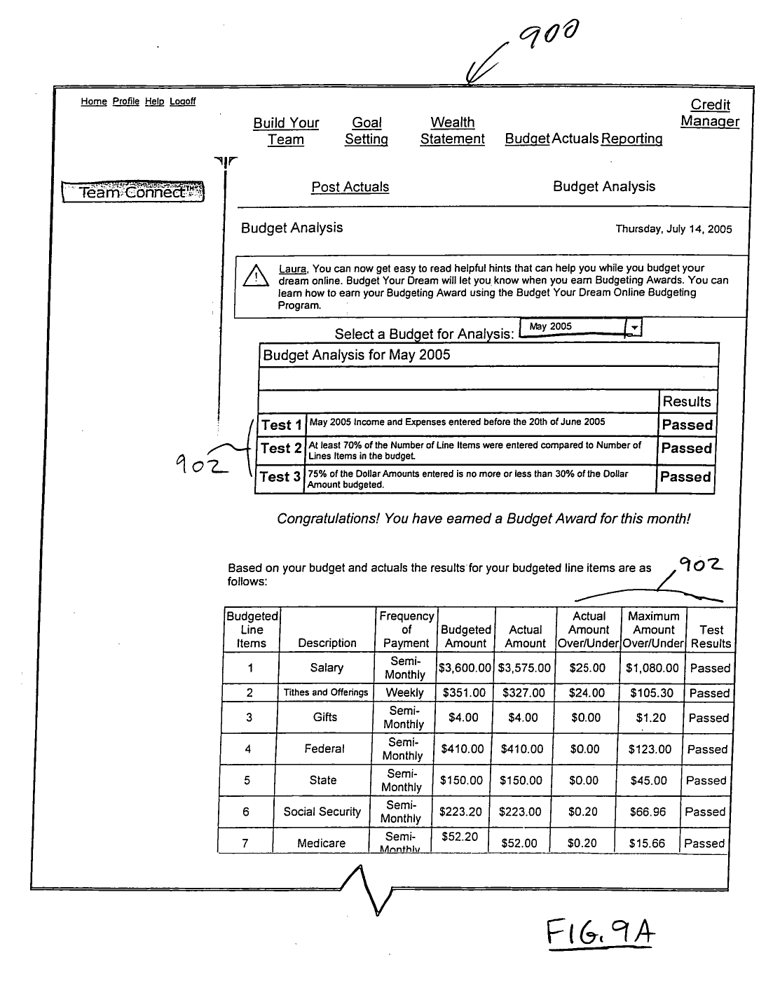

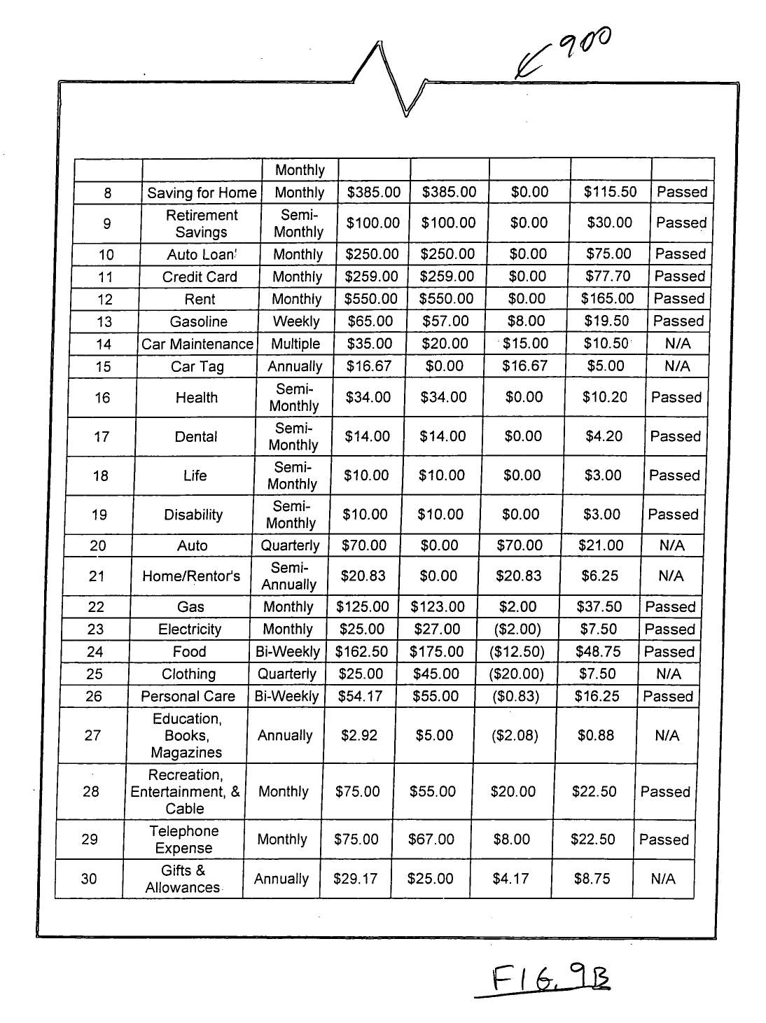

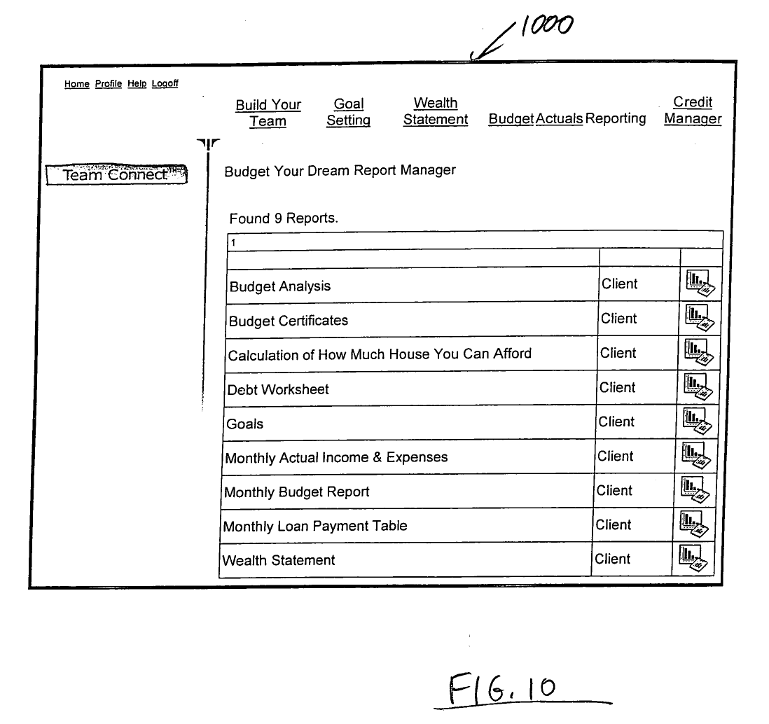

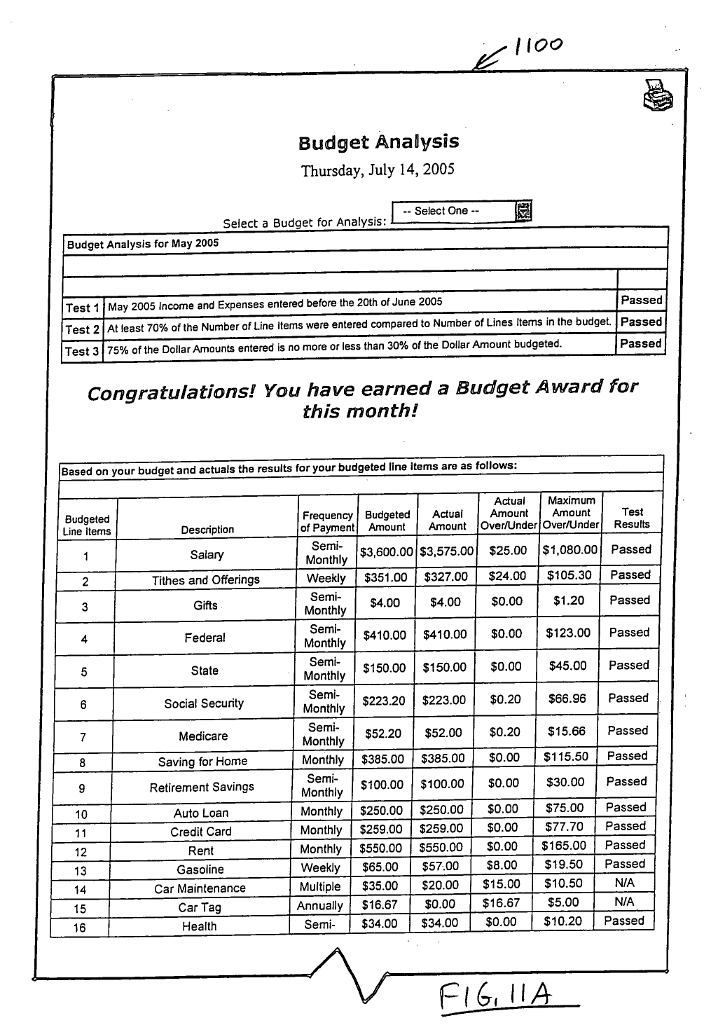

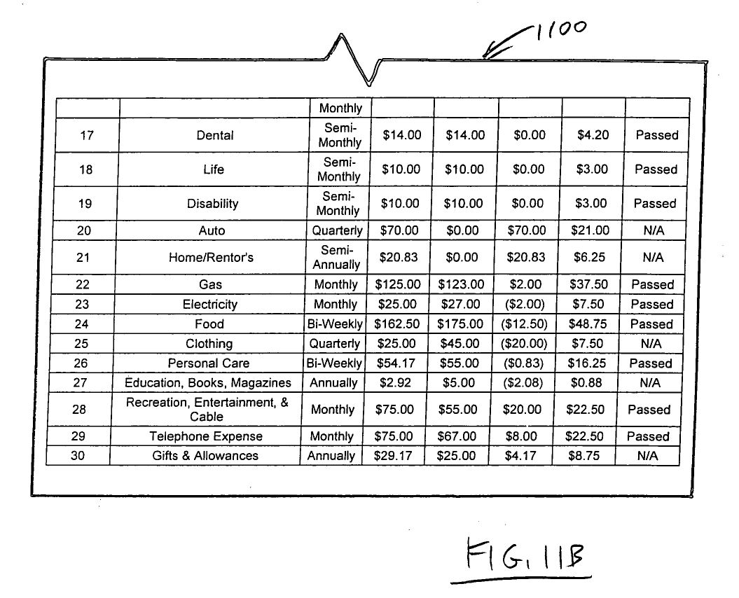

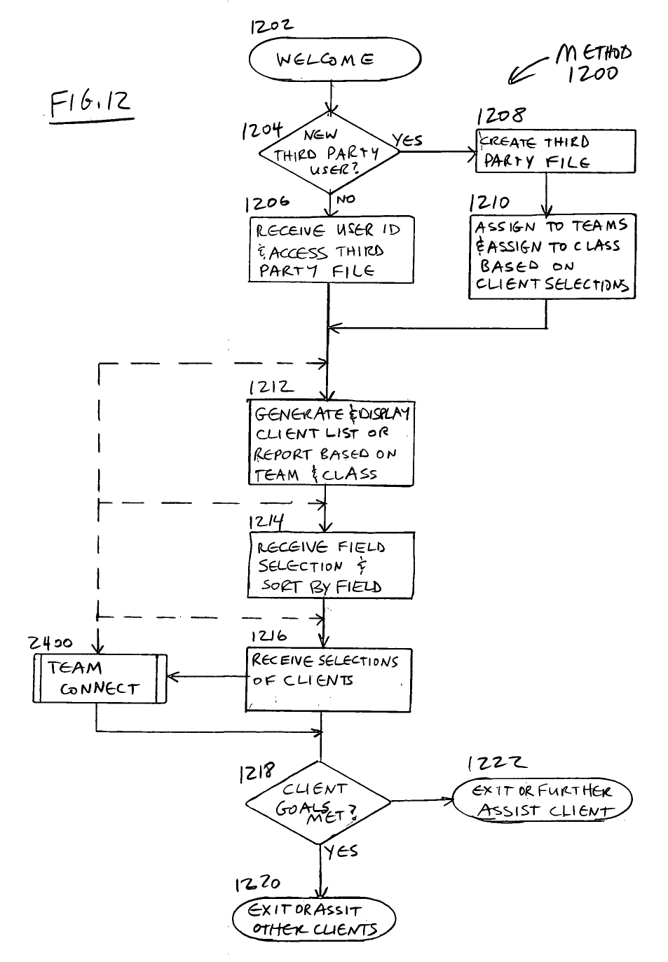

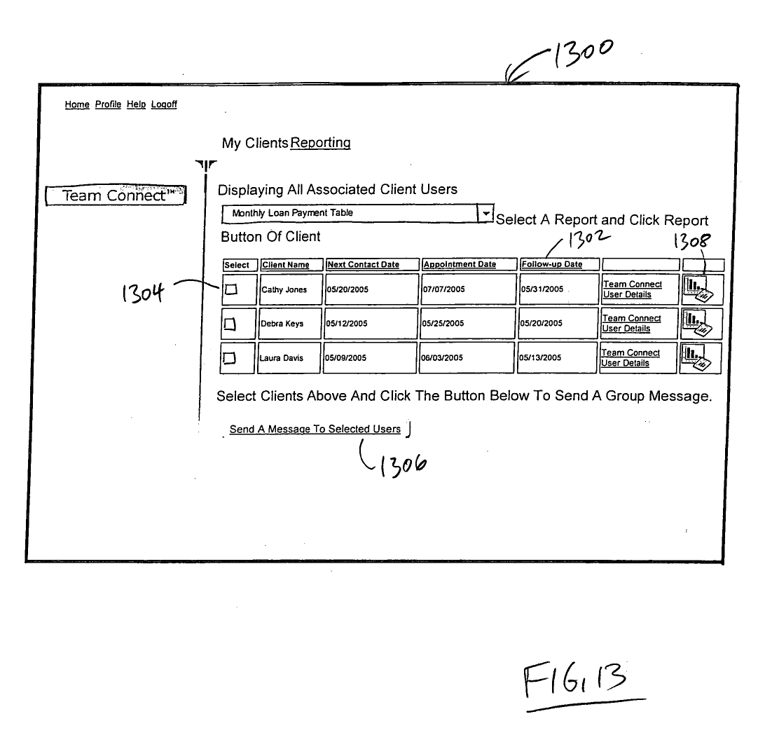

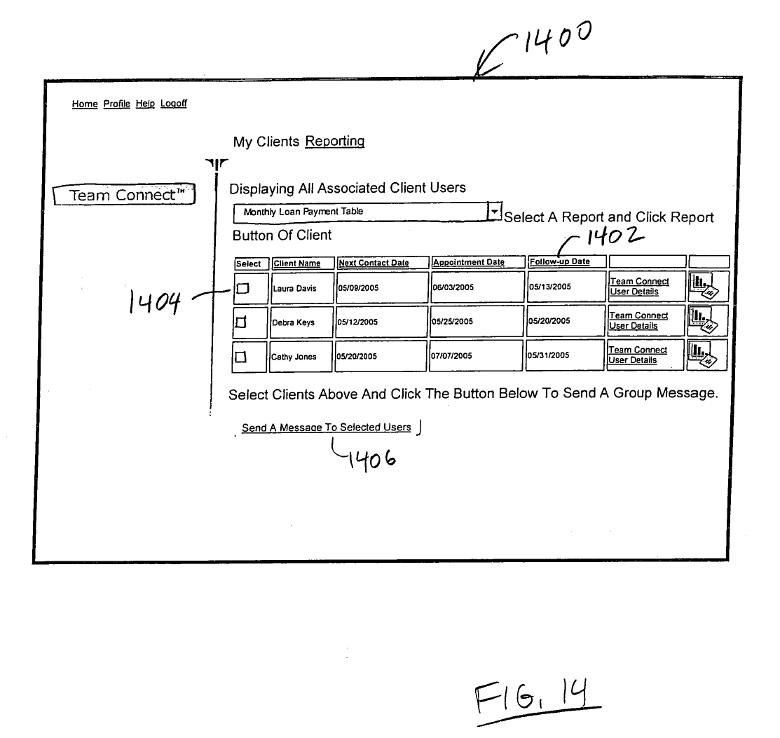

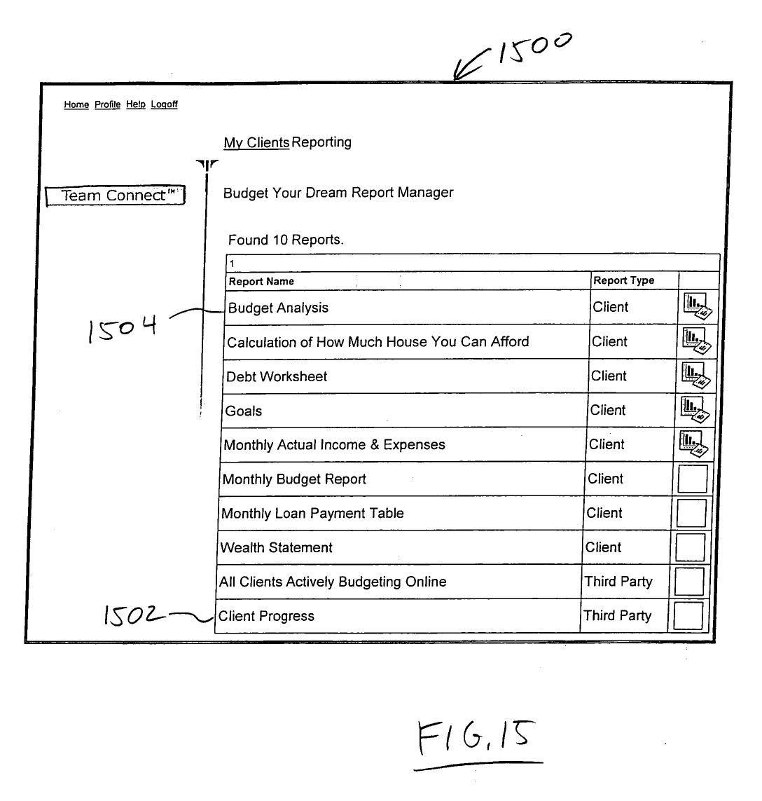

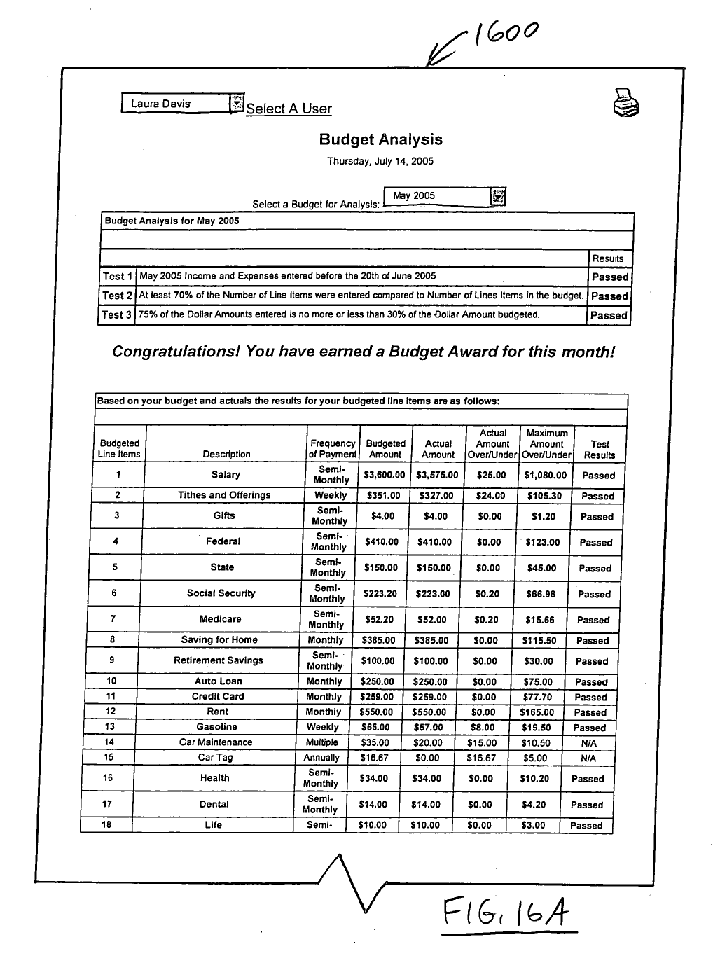

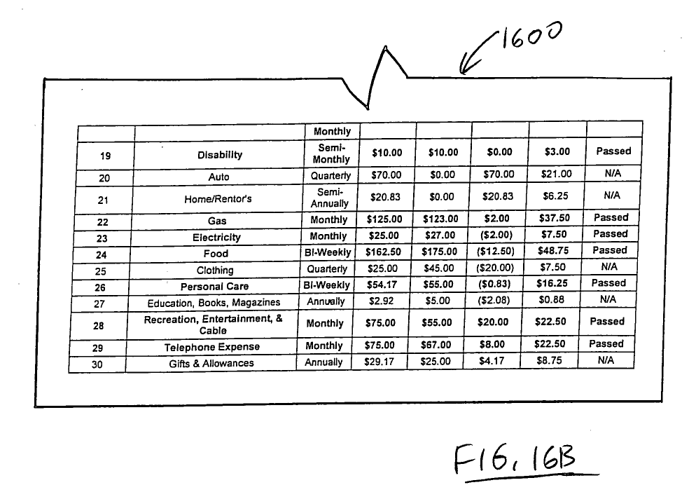

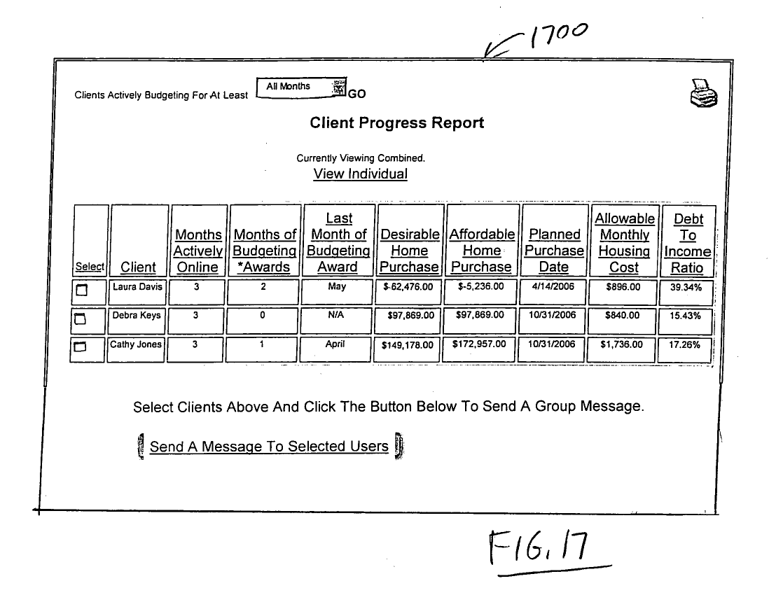

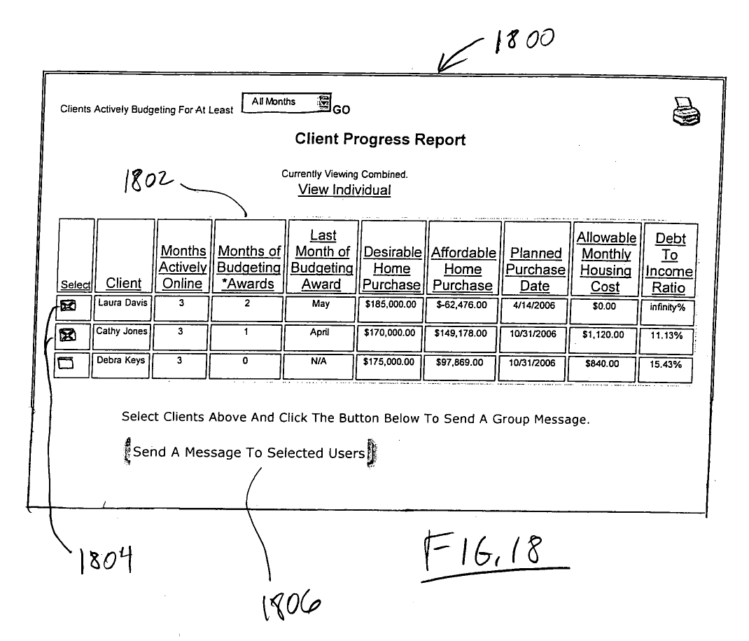

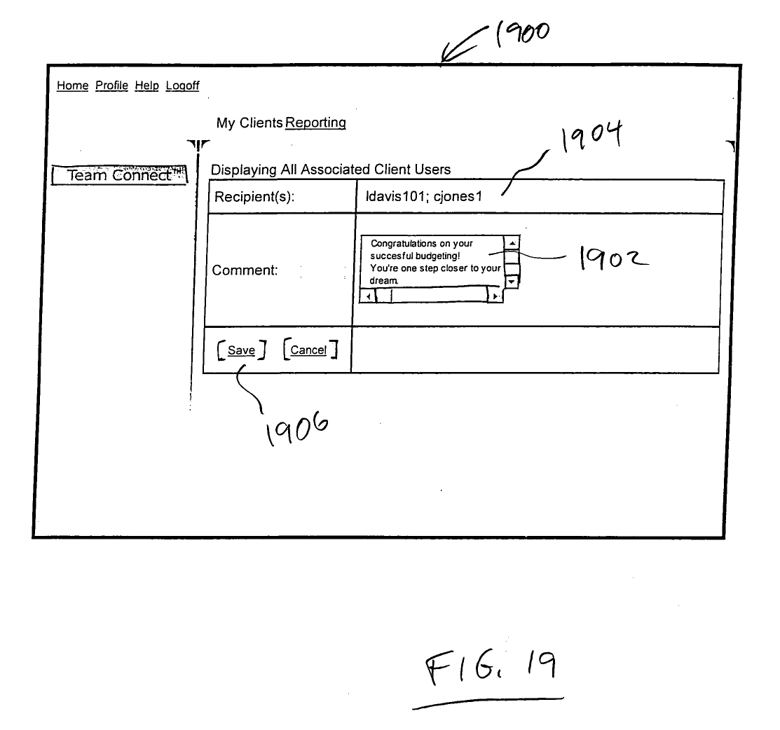

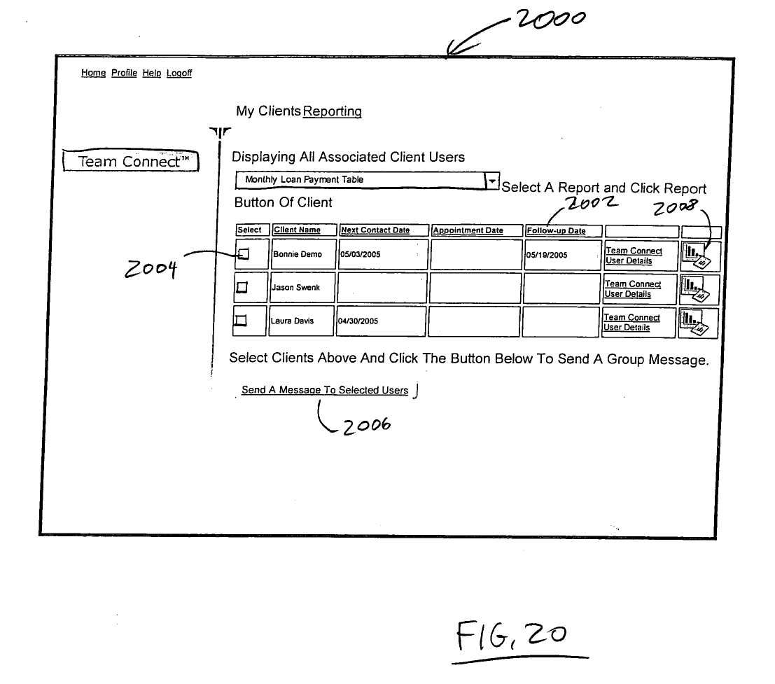

As the client receives its actual income and pays out its actual expenses, the client enters this actual financial information at 214 into a “post actuals” screen. An exemplary post actuals screen 800 is shown in FIGS. 8A, 8B, and 8C, collectively. The client can enter details for both incomes and expenses into an “expense tracker” module. The details entered, for example, from receipts for food and transportation, populate the line items selected for the actual incomes and expenses. An expense tracker icon 802 is listed for each budget line item. Preferably, the “post actual” screen includes fields showing the budgeted amount (previously entered in the budget component), the actual amount, and the variance between the two (which is calculated by the system).

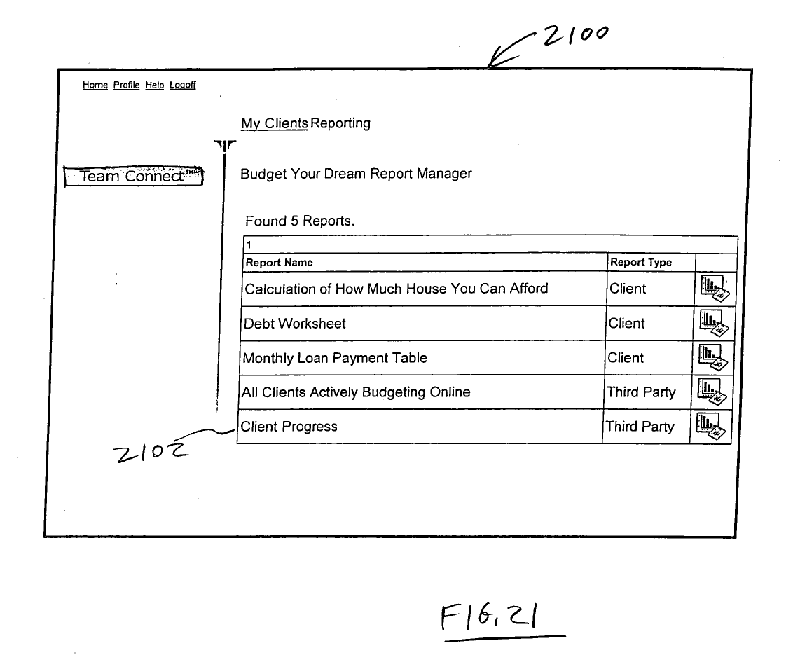

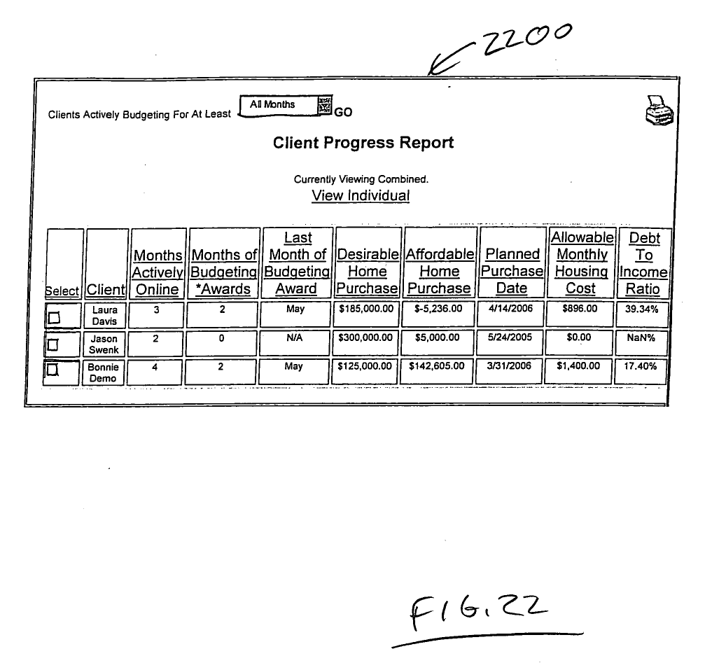

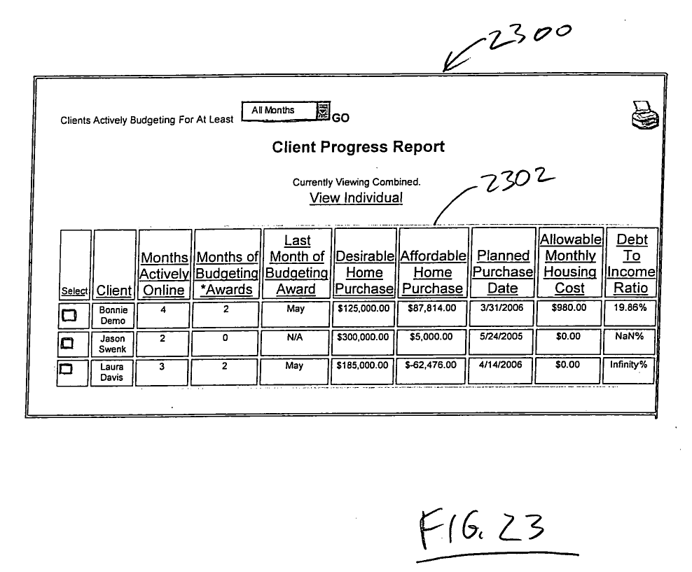

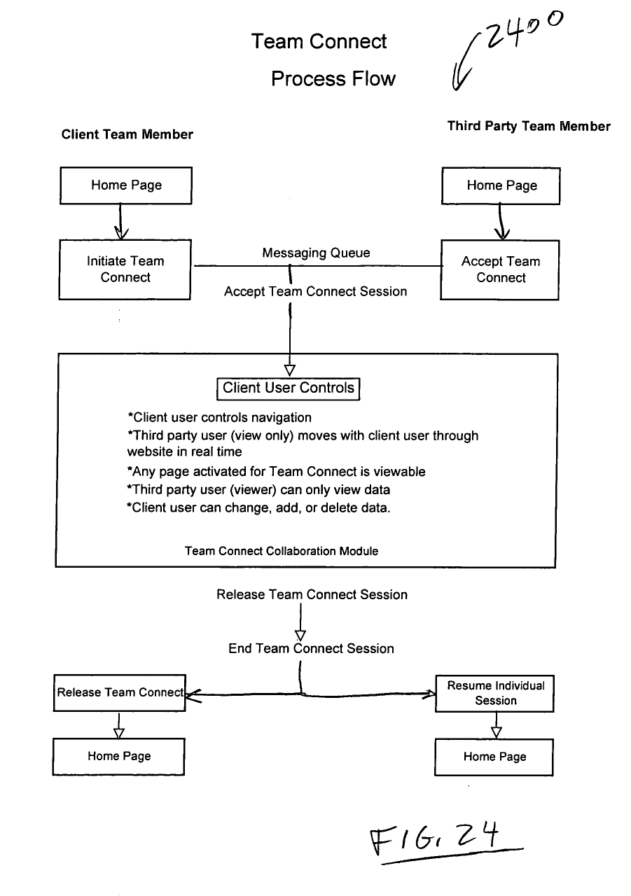

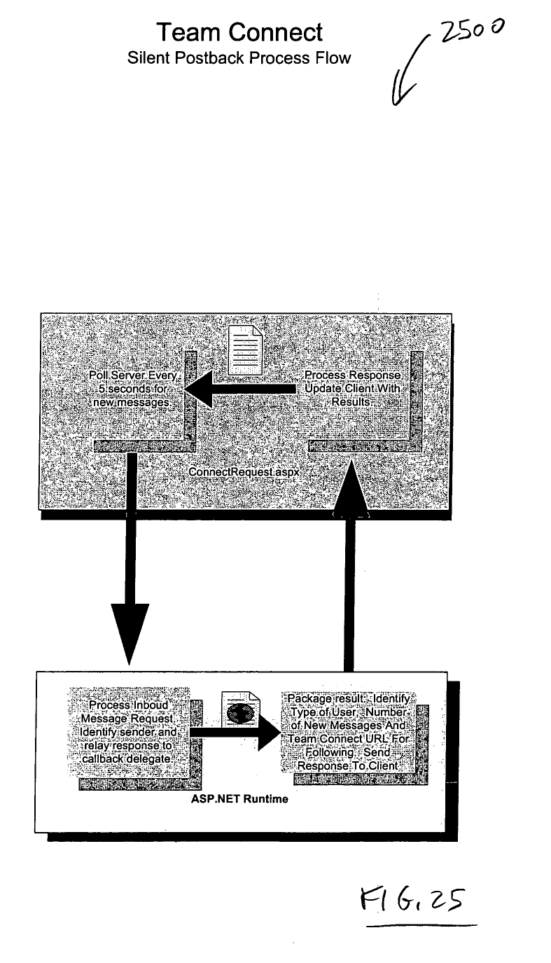

Then at 216 the system runs one or more budget tests to determine the budget results. As shown at 902 of an exemplary budget analysis screen 900 of FIGS. 9A and 9B, for instance, the system preferably runs tests for the client's entry of the actual financial information by a predefined regular deadline (e.g., the 20^{th} of each month), for receiving the actual financial information for a minimum percentage (e.g., 70 percent) of budget financial information line item entries, and for the dollar amounts of the entered actual financial information being within a predefined percentage range (e.g., 75 percent of actual amounts entered are within 30 percent) of the dollar amounts of the budget financial information line item entries. The budget test considers frequency of payment in its analysis to ensure integrity of test. By passing these tests the client demonstrates that he or she is committed to and is learning improved budgeting and saving, with the end result being an improved financial situation that is one step closer to the client's goals. The budget test methodology aids the clients in interactive learning and better financial management. The test results are also used as key indicator to the third party team members of the clients' financial progress. The test result data populates fields in certain third party reports that are used for monitoring, tracking and evaluating clients' financial progress as well as how effective a financial or housing counselor may be in helping their clients to meet their goals. The budget test is a very important component for data input into certain third party reports. These reports are used by the financial or housing counselors to determine which clients are successfully budgeting in order to better allocate their time to helping those clients in most need of counseling. The budgeting test is also used by the financial or housing counselor as a tool to save a minimum of 30 minutes per month for each client receiving counseling. The budget test automates the manual process of calculating budgeted compared to actual amounts and the manual budget analysis to determine clients' financial performances. Based on the system-automated calculation and analysis, the system renders an assessment. If the assessment yields an indication of successful budgeting based on predefined tests, the system generates a budgeting award for that month. The automated process of the system's budgeting analysis saves the financial and housing counselors the time of manually reviewing each client budget to determine an assessment of clients' financial performance.

After running the budget tests, at 218 the system checks to see if the client has hit any predefined milestones for successful budgeting. For example, the milestones can be predefined as six months of successful budgeting. If the client has reached a milestone, then at 220 the system issues an indication of budgeting success having value for the client. For example, the indication of budgeting success can be a certificate that can be printed by clicking on 302 of the welcome screen 300 of FIG. 3. It will be understood that other indications of budgeting success can be used in the system, including items such as medals and plaques. In any event, the client can redeem the certificate with one of the third party team members. Typically, the client redeems the certificate with the mortgage representative when purchasing a home and using the services of the mortgage representative. Preferably, for the third party mortgage representatives to enroll in the system, they must agree to accept the certificates from the clients and redeem them for a predetermined value (e.g., $50 for each certificate discounted from the mortgage companies fees at closing).

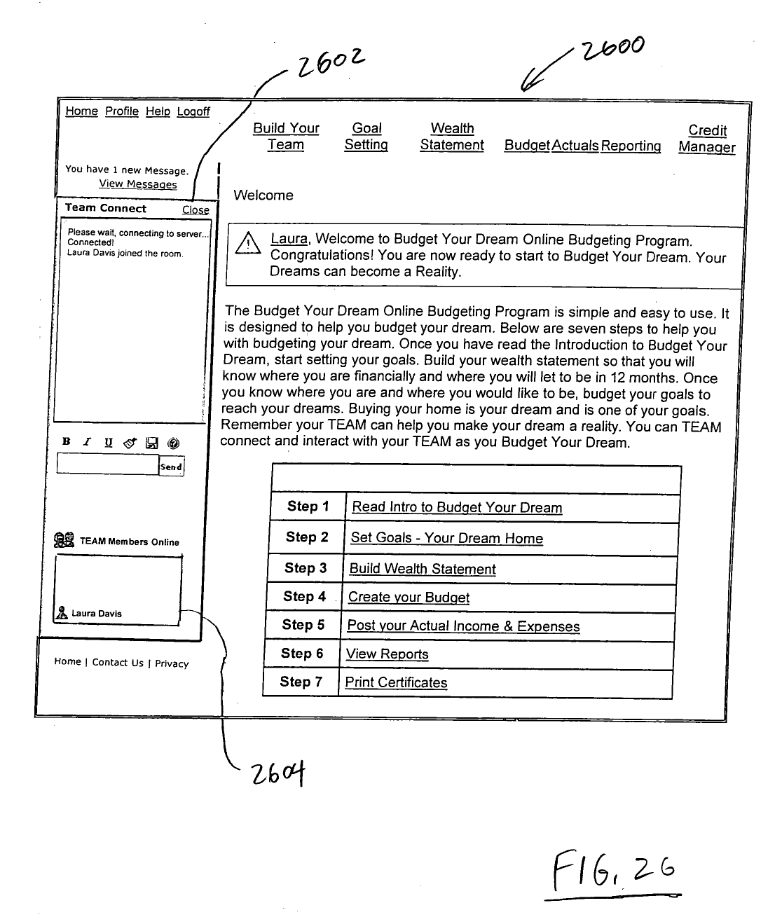

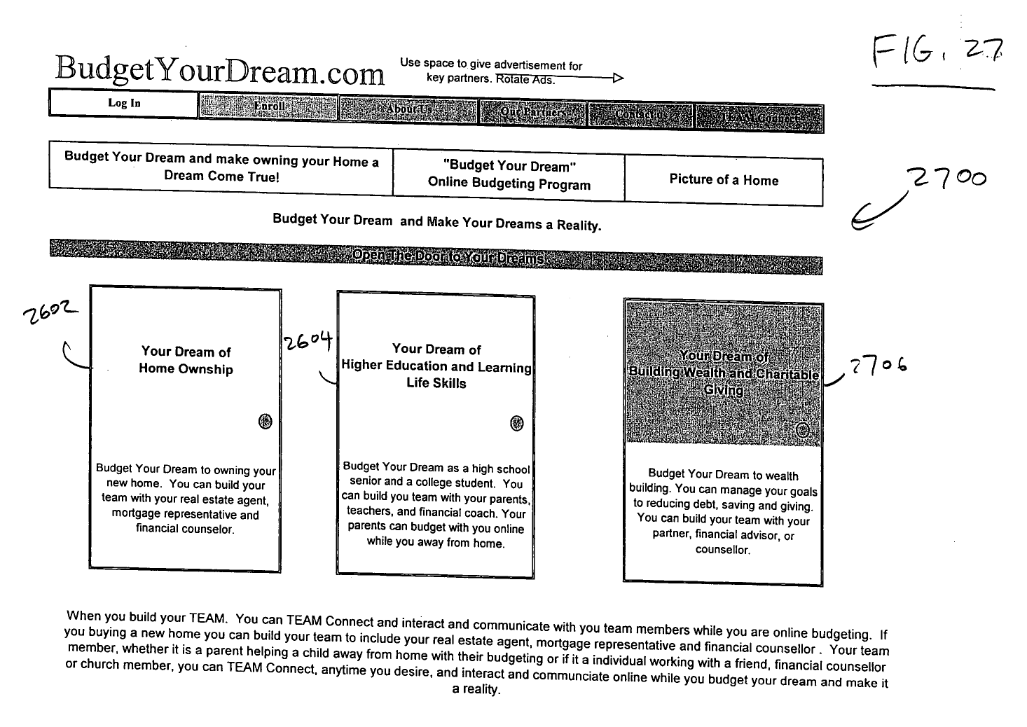

After the system runs the budget tests, at 222 the client can access reports generated by the system. An exemplary “reports” screen 1000 is shown in FIG. 10 and includes a menu of available reports. Preferably, the client has access to all of the reports the system generates. The exemplary budget analysis report 1100 shown in FIGS. 11A and 11B is a confidential financial report and is very useful for the client.

Finally, the system preferably updates the wealth statement with the actual financial information and determines if the client has successfully met its goals at 224. If the client has met its goals, then at 226 the client exits the system and is now able to realize its dream of purchasing a home. If the client has not yet met its goals, then at 228 the client exits the system and/or continues using the system over time for further budgeting and saving until it has met its goals.

Having described the method by which the clients use the system, and thus the programming loaded onto the server, we turn now to FIG. 12, which is a logic flow diagram showing a method 1200 of using the system 10 of FIG. 1 for third parties. In addition, FIGS. 13-23 depict a series of exemplary screen shots correlated to the steps of the method 200, with the screen shots of FIGS. 13-19 illustrative for a financial counselor team member and the screen shots of FIGS. 20-23 illustrative for a real estate agent team member.

The method 1200 includes at 202 the server sending the homepage screen to the user for display on its on-line user interface device. The login and enrollment processes for the third party users are the same as for the client users. Thus, at 1204 the process flow splits depending on whether the user is a new user or not. If the third party is an existing user, it logs in 1206 by entering its user identifiers, and the server then accesses the third party user's file. If the third party has not used the service before, it enrolls by entering certain required information at 1208 and selecting the appropriate user type from the drop-down menu.

In this case, however, the user is a third party and so it selects the “third party” user type from the drop-down menu in the enrollment process. When the third party selects its user type, at 1210 it is assigned the predetermined permission class associated with that user type. For the situation being illustrated, the financial counselor is assigned class one and the real estate agent is assigned class two. In addition, at 1210 the server assigns the third parties to the teams they have been selected for by the client users, and this team information is saved to the third party's file. Each of the third parties can be selected as a team member on a number of different client teams.

After the third party is enrolled, and whenever it accesses the website and enters its login information in the future, a customized welcome screen is displayed to the third party. From here or any other page on the website the client can navigate through the website pages to update its profile information, to access the help feature, to access a list of its clients, to access client reports available based on the third party's permission class, or to use the team connect component, as described below.

At 1212 the server generates and displays a client list or a report list when the third party user selects the corresponding button displayed on the welcome page and every other page. Upon clicking the my clients button, the server generates a screen with a list of the third party's clients, as shown in the exemplary “my clients” screens of FIGS. 13 and 20. The my clients screen 1300 is for a financial counselor and the my clients screen 2000 is for a real estate agent. In both cases, the screens 1300 and 2000 preferably include sortable fields for the third parties to enter client management information for each listed client, such as fields 1302 and 2002 for a date for a follow-up with the corresponding client. In addition, the screens 1300 and 2000 preferably include buttons 1304 and 2004 for selecting one or more clients and buttons 1306 and 2306 for clicking to send individual or group messages to the selected client or clients. Furthermore, the screens 1300 and 2000 preferably include buttons 1308 and 2008 for accessing the available reports associated with the corresponding client.

As shown for instance in the exemplary my clients screen 1400 of FIG. 14, at 1214 the third party user selects a field of client management information to sort by, and the server sorts by the field and regenerates the client list accordingly. In this case, the financial counselor has sorted by the follow-up date field 1402, which regenerates the report to make it easier to identify the counselor's next follow-up date and the client to follow-up with. At 1216, the counselor clicks on the client “select” button 1404 and the “send a message” button 1406 to send a message to initiate a follow-up with that client. Returning to step 1212, the server generates and displays a report list when the third party user selects the corresponding button displayed on the welcome page and every other page. Upon clicking the reporting button, the server generates a screen with list of the available reports associated with the corresponding client, as shown in the exemplary “reporting” screens of FIGS. 15 and 21. Clicking on a desired report name causes the server to send for display the selected report. The reporting screen 1500 is for a financial counselor and the reporting screen 2100 is for a real estate agent. As can be seen by comparing these screens, the financial counselor (class one permissions) has access to client reports not accessible by the real estate agent (class two permissions). For example, both the financial counselor and the real estate agent have access to at least one report such as a client progress report 1502 and 2102, but only the financial counselor has access to at least one other report, for example confidential financial reports such as the “budget” analysis report 1504 or a goals or other detailed financial report. FIGS. 16A and 16B shows an exemplary budget analysis report 1600 that is the same as the report 1100 shown in FIGS. 1A and 1B. And FIGS. 17 and 22 show an exemplary client progress report 1700 and 2200 for access by he financial counselor and the real estate agent.

At 1214 the third party team member selects a field of the report to sort by, and the server sorts by the field and regenerates the client list accordingly. In this case, the financial counselor has sorted by the months of budgeting awards field 1802 as shown in FIG. 18, which regenerates the report to make it easier to identify the financial counselor's team member clients who are doing well with their budgeting and those who need more assistance. Similarly, the real estate agent has sorted by the affordable home purchase field 2302 as shown in FIG. 23, which regenerates the report to make it easier to identify the real estate agent's team member clients who are most likely to result in a good sale for them.

Next, at 1216 the financial counselor has clicked two client select buttons 1804 of FIG. 18 to select two clients that he wants to communicate with because of their successful budgeting. This takes the counselor to the screen 1900 of FIG. 19, where the financial counselor has entered a group message in field 1902 directed to the selected clients 1904. The counselor then clicks the “save” button 1906, which takes him or her back to screen 18, where the “send message” button 1806 can be clicked to send the message. The server then sends each of the selected clients a notice that they have a new message, as at indicated at 304 of screen 300 of FIG. 3. The client recipient can click on “view messages” to view the new message (and/or previously read messages) or click on the “team connect” button 306 to join a team connect session and send and receive messages in real time with the group of users who are currently online. In this way, the financial counselor can more easily monitor his client team members and provide the needed collaboration to increase the likelihood that the clients who need help will get it and succeed in their budgeting.

Finally, as the third party's clients successfully meet their goals at 1218, then at 1220 the third party can proceed to use the system to assist another client. And for the clients who have not yet met their goals at 1218, then at 1222 the third party can continue to use the system to assist those clients. Once the goals are met, the client can continue to use the system as a life-long tool to maintain financial success.

Having described the methods of use of the system by the client users and the third party user, additional details of the team connect component 2400 will now be described. FIGS. 24 and 25 show the process flow 2400 and the silent post-back process flow 2500 for the team connect component 2400.

The team connect component 2400 is a unique feature that allows the clients to connect and interact online with its third party team members in two ways. First, the client and third party team members can use the team connect component as a communication medium for exchanging messages with each other, either individual messages to individual team members or group messages to an entire team, while the client works on his or her budget. Second, the client and third party team members can use the team connect component in order to share data and work together in monitoring data and progress. These two ways of collaborating using the team connect component contribute to the likelihood of successful budgeting by the clients.

The team connect component 2400 employs multiple layers of software to seamlessly allow the client and third party team members to communicate while viewing the same information through an Internet browser window. The team connect component includes a chat module so that the team members can exchange messages using a chat window. Of course, the team members could alternatively converse over the telephone instead of using the chat module. Either way, the team connect component allows the team members to coach, instruct, educate, interact, share data, and collaborate with each other in real time from locations remote to each other.

The team connect component is designed around the system architecture for the other components. Each webpage is embedded with team connect component framework, which contains a chat module, a messaging list, a request queue, a permissions layer, and a collaboration module.

When one team member (client or third party) requests a team connect session with another team member by clicking on the “team connect” button (e.g., button 306 of screen 300 of FIG. 3), the messaging queue notifies the requested team member of the request. The requested team member has the option to accept the request by clicking on the team connect button to join the team connect session, or to reject (affirmatively or by not responding) the request.

When a user clicks on the team connect button, the team connect component is initiated and a team connect box 2602 opens on the user's screen, as show in exemplary screen 2600 of FIG. 26. For a client user, the team connect box 2602 includes a field 2604 listing the team members currently on line and available for communicating in real time. On the other hand, for a third party user the team connect box first includes a field listing the teams on which the third party is a member. And after the third party user clicks on a selected team from the field, then the third party views a screen with a team connect box similar to the box 2602 in that it includes a field similar to field 2604 listing the team members currently on line and available for communicating in real time.

Either way, if the requested user accepts the request to join the team connect session, then the collaboration module functions so that the third party team member(s) will be navigated through the site following the lead of the client team member. The client team member and the third party team members view the same data and pages. Thus, if the client navigates to the progress report screen, then the client team member and each third party team member active in the team connect session will view the same progress report screen. The third party team members only have view access and cannot navigate to other pages.

In addition, each webpage is assigned a given set of permissions to tell the system which class of third party team members has view access during team connect sessions. In particular, class one team members have a higher level of access than do class two team members. For example, when the client team member accesses the client progress report, then a financial counselor (class one permissions) and a real estate agent (class two permissions) will both view this report. But when the client team member accesses the client's confidential financial reports, such as the budget analysis, wealth statements, goals, and actual expense statements, then the financial counselor will view these reports but not the real estate agent.

This unique form of collaboration provided by the team connect component is very secure over an Internet connection while giving the client and third party team members the ability to view the same data and be coached on the associated information.

In addition, it should be noted that the system can be adapted to allow the third-party users (view only) to be granted add, change, and delete privileges. The third-party users are navigated through the program with the information from the client user but the system has the ability to allow the third party users certain rights to move independently to sub-locations (based on predefined parameters) even when the third party team member is navigated by the movement of the client through the program.

In a second example embodiment of the invention, the program includes all three of the above-mentioned modules, namely, budgeting for (1) home ownership; (2) higher education and life skills; and/or (3) sound financial management and good stewardship. Accordingly, the target groups for using the program include, for example, prospective homebuyers, high school and college students, and church members, who all use the same web site.

FIG. 27 depicts a typical website home page 2700 for this embodiment of the invention. The user clicks on the button for the module he or she wants to use, and the program then starts the process for that specific module. If the user selects the “home ownership” module 2702, then he or she it taken through the process described above.

If the user selects the “higher education and life skills” module 2704, then he or she is taken through a process that is similar to that described above for the “home ownership” module but that is modified based on the different savings goal and user group.

Generally described, this module of the program is a web-based incubator designed to produce budgeting success for high school and college students. The budgeting program is an effective tool to teach high school seniors and other youths the important life skill of successful budgeting. High school seniors could be enrolled in the program during the beginning of their senior year and use the program from home or any desirable location with web access. The school's personnel (e.g., teacher) would then be able to monitor student success from a remote location as she/he desires via the web. The budgeting program will provide responses to help guide the student into preparing successful budgets. As with the home purchase module, this module uses a team connect component providing value-added collaboration to allow others students, parents, etc. to be involved online with helping, monitoring, and interacting with a student during the budgeting process. The team is allowed the opportunity for all parties to work together to motivate and keep the student focused on successful budgeting.

In particular, this module of the program is designed to help a high senior student budget with the opportunity for collaboration with third party team members such as teachers, parents, or other students in a cost-effective and efficient manner. The program provides the ideal management tool for the teacher and school personnel to monitor student performance with simple and easy reading reports that highlight the student's progress. Reports are automatically generated once a student reaches certain milestones in preparing monthly budgets.

As the student completes successful budgeting, he or she will earn indications of success such as valuable certificates that can be used to earn school extra credit points. The high school program preferably integrates corporate/institution sponsorship and partnership to assist schools in financing the annual fee of using the budgeting program. For example, a student who reaches predetermined milestones in the budgeting process will earn a certificate that can be redeemed when making purchases from merchants who are members (sponsors, partners, etc.) of the program. The student gains by learning to budget and be financially responsible and successful. In addition, this module may include components for allowing parents of the high school student to budget and save for the student's college education. And the merchants gain by helping students become financially stable customers who will make many repeat purchases in the future, as well be by doing a good thing. The application applies to colleges and universities to be used as a supplemental aid to teach life application skills with the personal financial management courses. The program could be used as a training tool to allow the students and educators to collaborate together throughout the budgeting experience in order to aid in the personal financial learning and hands-on applications. The educators could enroll as a third party member and have full access to the student budgeting and financial data in order to monitor, track and evaluate the student learning. The third party reports include a summary of all students that are budgeting successfully based on the budget test methodology. Specific test parameters can be modified to make the budget test more or less stringent. The program can also be used by the schools to allow students to collaborate, monitor, track, evaluate, and counsel each other.

And finally, if the user selects the “building wealth and charitable giving” 2706 module, then he or she is taken through a process that is similar to that described above for the “higher education and life skills” module but that is slightly modified based on the sound financial management and good stewardship goals. The program is an effective tool for churches. Most churches are very interested in good stewardship or faithful stewardship of their members when it comes not only to their spiritual progress but also their finances. The program is an excellent tool that can help churches help their members with budgeting and managing their finances.

The program solves several problems for churches, including:
1. Budgeting—The lack of budgeting is one of the major causes of most financial problems for individuals. Now there is a simple and easy-to-use online budgeting program that is designed for the minimum-skilled computer user and financial manager.
2. Training and Coaching—Lack of financial education, knowledge, and motivation is another major roadblock. The church can now use this easy-to-use and simple tool to budget and help their members through the process by using the online features, including team connect component.
3. Time and Effort—The churches that attempt to provide free financial education and budgeting struggle with the problem of being able to meet with each church member regularly for one-on-one counseling. Too often meeting rooms and space must be coordinated with the church office, which is also time-consuming. The challenge of coordinating meeting times and location overwhelms the church volunteer, therefore, the counseling session rarely occurs. However, with the program, one-on-one meetings no longer have to occur in the old-fashioned way. These meetings can occur online with the ease and convenience of never traveling, at any time of day or night. The volunteer from the church can simply go online and view the church member's budget and then use the team connect component for interaction and communication. These meetings can be immediate and impromptu, without the hassle of a drive across town to meet and discuss the budget. The program also provides quick assessment of the member's budgeting success to help the volunteer know whether or not the church member is budgeting successfully and on time.
4. Debt and a Lack of Tithing—Churches are challenged with members that are in too much debt and provide too little amounts of contributions (“tithes and offerings”). Churches desire financial solutions to help their members become better stewards of their finances. The result is an increase in financial wealth for both the member and the church. The church wants to be able to help increase the member's contributions to the church. The program gives the church, with the help of its financial ministry, a tool to work easily in helping its members to improve their budgeting, stewardship, and giving.

With these advantages and solutions, the program can help church members, and in fact all Americans and peoples of other nations, learn to successfully budget and become more financially successful. Churches can use the program as a tool to help their members to begin to budget their dreams of better money management and giving.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. In addition, as used in the specification including the appended claims, the singular forms “a,” “an,” and “the” include the plural, plural forms include the singular, and reference to a particular numerical value includes at least that particular value, unless the context clearly dictates otherwise. Furthermore, any methods described herein are not intended to be limited to the sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

What is claimed is:

1. A computer network-implemented budgeting and saving method for use by clients and interested third parties, comprising:
a) receiving from an active one of the clients a selection of at least one of the third parties as a class one team member and a selection of at least one other of the third parties as a class two team member;
b) receiving budget financial information and actual financial information from the active client;
c) determining budgeting results based on the budget financial information and the actual financial information, wherein the budget financial information, the actual financial information, and the budgeting results collectively define financial management information;
d) generating reports including at least one first report based on the financial management information for the active client; and
e) permitting remote access to the first report by the active client and the class one team member but not by the class two team member, the third parties not selected by the active client, or the other clients,
wherein the active client and the client-selected team members can collaborate from remote locations to facilitate improved budgeting and saving by the active client.

2. The method of claim 1, wherein the clients include prospective homebuyers, the class one team member is selected from the third party group consisting of financial counselors, housing counselors, and financial coaches, and the class two team member is selected from the third party group consisting real estate agents and mortgage representatives.

3. The method of claim 1, wherein the step of generating reports includes generating at least one second report based at least in part on the financial management information, and further comprising permitting remote access to the client progress report by the class one team member and the class two team member.

4. The method of claim 3, wherein the first report is a confidential financial report, the second report is a client progress report, and the step of generating the client progress report includes retrieving client-specific information for all of the clients that entered a selection of the team member, and permitting remote access to the retrieved client-specific information by the team member.

5. The method of claim 4, wherein the client progress report is displayed to the team member with the client-specific information for the included clients arranged in fields and sortable by the fields, wherein the team member can sort by the fields to monitor budgeting progress of the included clients.

6. The method of claim 5, further comprising receiving from the team member a selection of one or more of the clients included in the client progress report, retrieving contact information for the selected clients, receiving a group message from the team member, and sending the group message to all of the selected clients simultaneously, wherein the team member can sort by the fields to identify budgeting status of the included clients and remotely communicate group messages to selected groups of the included clients.

7. The method of claim 3, further comprising receiving screen selections from the active client as the active client navigates through the reports, displaying the confidential financial report corresponding to one of the screen selections to the active client and the class one team member but not to the class two team member, and displaying the client progress report corresponding to another of the screen selections to the active client, the class one team member, and the class two team member.

8. A server computer or bank of server computers connected to a computer network and storing computer-executable instructions for performing the method of claim 1.

9. A computer-readable storage medium storing computer-executable instructions for performing the method of claim 1.

10. A computer network-implemented budgeting and saving method for use by clients and interested third parties, comprising:
a) receiving from an active one of the clients a selection of at least one of the third parties as a team member;
b) receiving budget financial information and actual financial information from the active client;
c) determining budgeting results based on the budget financial information and the actual financial information, wherein the budget financial information, the actual financial information, and the budgeting results collectively define financial management information,
d) generating reports based on the financial management information for the active client; and
e) permitting remote access to at least one of the reports by the team member but not by the other clients or the third parties not selected by the active client,
wherein the active client and the client-selected team members can collaborate from remote locations to facilitate improved budgeting and saving by the client.

11. The method of claim 10, wherein the clients include prospective homebuyers, and the team member is selected from the group consisting of financial counselors, housing counselors, financial coaches, real estate agents and mortgage representatives.

12. The method of claim 10, further comprising determining whether the budgeting results meet a predefined milestone for successful budgeting and if so then awarding an indication of budgeting success to the active client, wherein the team member is a mortgage representative and, as a condition of enrollment and selection as a team member, the mortgage representative agrees to grant to the active client a reward of value that is applicable to a home purchase and based on the indication of budgeting success.

13. The method of claim 12, wherein the indication of budgeting success comprises a certificate.

14. The method of claim 10, wherein the step of generating reports includes generating at least one predetermined client progress report based at least in part on the financial management information, wherein the client progress report includes client-specific information for all of the clients that entered a selection of the team member and the client progress report is displayed to the team member with the client-specific information for the included clients arranged in fields and sortable by the fields, wherein the team member can sort by the fields to monitor budgeting progress of the included clients.

15. The method of claim 14, wherein the step of generating the client progress report includes generating the client progress report automatically at regular intervals correlated to predefined regular budgeting periods.

16. The method of claim 14, further comprising receiving from the team member a selection of one or more of the clients included in the client progress report, retrieving contact information for the selected clients, receiving a group message from the team member, and sending the group message to all of the selected clients simultaneously, wherein the team member can sort by the fields to identify budgeting status of the included clients and remotely communicate group messages to selected groups of the included clients.

17. The method of claim 10, wherein the step of receiving the team member selection includes receiving a selection of at least two team members into a team with the active client, and further comprising receiving a message from the active client or one of the team members and sending the message to all of the others on the team.

18. The method of claim 10, further comprising receiving screen selections from the active client as the active client navigates through the reports, and displaying to the active client and the team member the reports corresponding to the screen selections.

19. The method of claim 18, further comprising not displaying predetermined ones of the reports to predetermined ones of the team members as the active client navigates through the reports.

20. The method of claim 10, further comprising receiving screen selections from the team member as the team member navigates through the reports, and not displaying to the active client the reports corresponding to the screen selections.

21. The method of claim 10, further comprising receiving initial and updated profile information from the clients, and permitting remote access by the team members to the client profile information for all of the clients that entered a selection of the team member, wherein the team members maintain access to the updated profile information without the team members having to update the profile information.

22. The method of claim 10, further comprising receiving enrollments from the third parties into class one or class two, wherein the step of receiving the active client team member selection comprises receiving a selection of at least one of the class one third parties as a class one team member and a selection of at least one of the class two third parties as a class two team member.

23. The method of claim 22, wherein the clients include prospective homebuyers, the class one team member is selected from the group consisting of financial counselors, housing counselors, and financial coaches, and the class two team member is selected from the group consisting real estate representatives and mortgage representatives.

24. A server computer or bank of server computers connected to a computer network and storing computer-executable instructions for performing the method of claim 10.

25. A computer-readable storage medium storing computer-executable instructions for performing the method of claim 10.

26. A computer storage medium storing computer-readable instructions and data, comprising:
a database storing profile information and financial management information for clients, wherein the financial management information includes budget financial information, actual financial information, and budgeting results;
a budgeting component for determining the budgeting results based on the budget financial information and the actual financial information;
a report generator for generating reports based on the financial management information;
a team building component for receiving from an active one of the clients a selection of interested third parties as team members, wherein the active client and the team members define a team, and at least one of the team members is permitted remote access to at least one of the reports for the active client; and
a team connect component for receiving a message from the active client or one of the team members and sending the message to all of the others on the team in real time,
wherein when the computer storage medium is loaded onto a server computer connected to a communications network, the active client and the client-selected team members can collaborate from remote locations to facilitate improved budgeting and saving by the client.

27. The computer storage medium of claim 26, further comprising programming for receiving enrollments from the third parties into class one or class two, and wherein the team building component is programmed for receiving from the active client a selection of at least one of the class one third parties as a class one team member and a selection of at least one of the class two third parties as a class two team member.

28. The computer storage medium of claim 27, wherein the clients include prospective homebuyers, the class one team member is selected from the group consisting of financial counselors, housing counselors, and financial coaches, and the class two team member is selected from the group consisting real estate agents and mortgage representatives.

29. The computer storage medium of claim 27, wherein the report generator is further programmed for generating at least one predetermined confidential financial report based on the financial management information for the active client, and further comprising programming for permitting remote access to the confidential financial report by the active client and the class one team member but not by the class two team member, the third parties not selected by the active client, or the other clients.

30. The computer storage medium of claim 29, wherein the report generator is further programmed for generating at least one predetermined client progress report based on the financial management information for the active client, and further comprising programming for permitting remote access to the client progress report by the class one team member and the class two team member.

31. The computer storage medium of claim 27, wherein the team connect component includes a collaboration module for receiving inputs from the active client as the active client accesses the financial management information and displaying to the active client and the class one team member but not the class two team member the financial management information corresponding to one of the inputs.

32. The computer storage medium of claim 26, wherein the report generator is further programmed for generating at least one predetermined client progress report that is based on the financial management information for the active client and that includes client-specific information for the included clients arranged in fields and sortable by the fields.

33. The computer storage medium of claim 32, wherein the report generator and the team connect component are programmed for receiving from an active one of the team members a selection of one or more of the clients included in the client progress report, retrieving contact information for the selected clients, receiving a group message from the active team member, and sending the group message to all of the selected clients simultaneously, wherein the active team member can sort by the fields to identify budgeting status of the included clients and remotely communicate group messages to selected groups of the included clients.

34. The computer storage medium of claim 26, wherein the team connect component includes a collaboration component for receiving screen selections from the active client as the active client navigates through display screens, displaying to the active client and permissioned ones of the team members the display screens corresponding to the screen selections.

34. The computer storage medium of claim 26, further comprising a goal-setting component for receiving inputted financial goals from the clients and inputted selections for adding the goals to the budget financial information.

35. The computer storage medium of claim 26, further comprising a budget test methodology including at least one predefined criteria for determining the budget results.

36. A computer storage medium storing computer-readable instructions and data, comprising:
a database storing profile information and financial management information for clients, wherein the financial management information includes budget financial information, actual financial information, and budgeting results;
a budgeting component for determining the budgeting results based on the budget financial information and the actual financial information;
a budget test methodology including at least one predefined criterion for determining the budget results;
a report generator for generating reports based on the financial management information;
a team building component for receiving from an active one of the clients a selection of interested third parties as team members, wherein the active client and the team members define a team, and at least one of the team members is permitted remote access to at least one of the reports for the active client; and
a team connect component for receiving a message from the active client or one of the team members and sending the message to all of the others on the team in real time,
wherein when the computer storage medium is loaded onto a server computer connected to a communications network, the active client and the client-selected team members can collaborate from remote locations to facilitate improved budgeting and saving by the client.

37. The computer storage medium of claim 36, wherein the budget test methodology includes:
a) receiving the actual financial information by a predefined regular deadline;
b) receiving the actual financial information for a minimum percentage of budget financial information entries; and
c) the actual financial information entered being within a predefined percentage range of the budget financial information entries.
